(19) United States
(12) Patent Application Publication
(10) Pub. No.: US 2025/0227767 A1
(43) Pub. Date: Jul. 10, 2025

(54) METHOD AND APPARATUS FOR ON-DEMAND SYSTEM INFORMATION IN A WIRELESS COMMUNICATION SYSTEM

(71) Applicant: ASUS Technology Licensing Inc., Taipei City 112028 (TW)

(72) Inventor: Ko-Chiang Lin, Taipei City (TW)

(21) Appl. No.: 19/009,288

(22) Filed: Jan. 3, 2025

Related U.S. Application Data
(60) Provisional application No. 63/617,483, filed on Jan. 4, 2024.

(51) Int. Cl. H04W 74/0833; H04W 74/00; H04W 74/08

(52) U.S. Cl. CPC H04W 74/0833; H04W 74/006; H04W 74/0891

(57) ABSTRACT

A method and device for a User Equipment (UE) are disclosed. In one embodiment, the UE initiates a random access procedure to request a first system information on a serving cell. Furthermore, the UE receives an indication in a Random Access Response (RAR) indicating a time pattern and/or periodicity and/or offset and/or search space for monitoring a Physical Downlink Control Channel (PDCCH) for the first system information. In addition, the UE monitors the PDCCH for the first system information on the serving cell based on the indication in the RAR.

### CROSS-REFERENCE TO RELATED APPLICATIONS

The present application claims the benefit of U.S. Provisional Patent Application Ser. No. 63/617,843 filed on Jan. 4, 2024, the entire disclosure of which is incorporated herein in its entirety by reference.

### FIELD

This disclosure generally relates to wireless communication networks, and more particularly, to a method and apparatus for on-demand system information in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and device for a User Equipment (UE) are disclosed. In one embodiment, the UE initiates a random access procedure to request a first system information on a serving cell. Furthermore, the UE receives an indication in a Random Access Response (RAR) indicating a time pattern and/or periodicity and/or offset and/or search space for monitoring a Physical Downlink Control Channel (PDCCH) for the first system information. In addition, the UE monitors the PDCCH for the first system information on the serving cell based on the indication in the RAR.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of FIG. 4.3.1-1 of 3GPP TS 38.211 V15.7.0.

FIG. 6 is a reproduction of Table 8.2-1 of 3GPP TS 38.213 V18.0.0.

FIG. 7 is a reproduction of Table 8.2-2 of 3GPP TS 38.213 V18.0.0.

FIG. 8 is a reproduction of Table 13-0 of 3GPP TS 38.213 V18.0.0.

FIG. 9 is a reproduction of Table 13-1 of 3GPP TS 38.213 V18.0.0.

FIG. 10 is a reproduction of Table 13-16 of 3GPP TS 38.213 V18.0.0.

FIG. 11 is a reproduction of Table 13-17 of 3GPP TS 38.213 V18.0.0.

FIG. 12 is a flow chart according to one exemplary embodiment.

FIG. 13 is a flow chart according to one exemplary embodiment.

FIG. 14 is a flow chart according to one exemplary embodiment.

FIG. 15 is a flow chart according to one exemplary embodiment.

FIG. 16 is a flow chart according to one exemplary embodiment.

FIG. 17 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: TS 38.211 V15.7.0, “NR; Physical channels and modulation (Release 15)”; TS 38.213 V18.0.0, “NR; Physical layer procedures for control (Release 18)”; TS 38.321 V17.6.0, “NR; Medium Access (MAC) protocol specification (Release 17)”; TS 38.331 V17.6.0, “NR; Radio Resource Control (RRC) protocol specification (Release 17)”; and RP-234065, “New WID: Enhancements of network energy savings for NR”, Ericsson. The standards and documents listed above are hereby expressly incorporated by reference in their entirety.

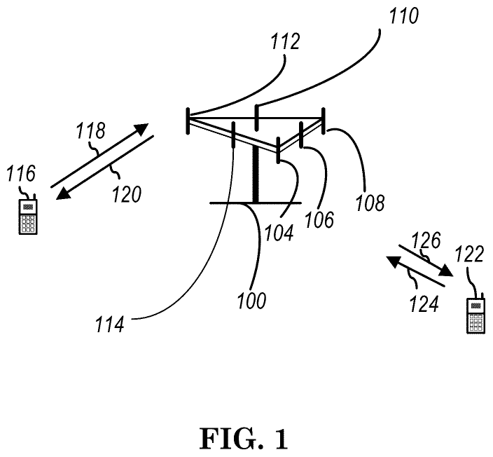

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), a network node, a network, or some other terminology. An access terminal (AT) may also be called user equipment (UE), a wireless communication device, terminal, access terminal or some other terminology.

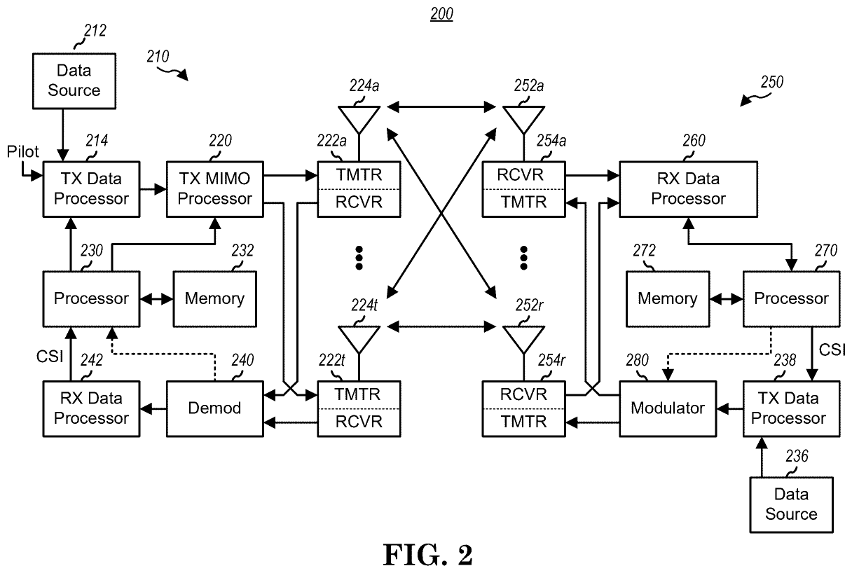

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides Nr modulation symbol streams to Nr transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. Nr modulated signals from transmitters 222a through 222t are then transmitted from N_{T} antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

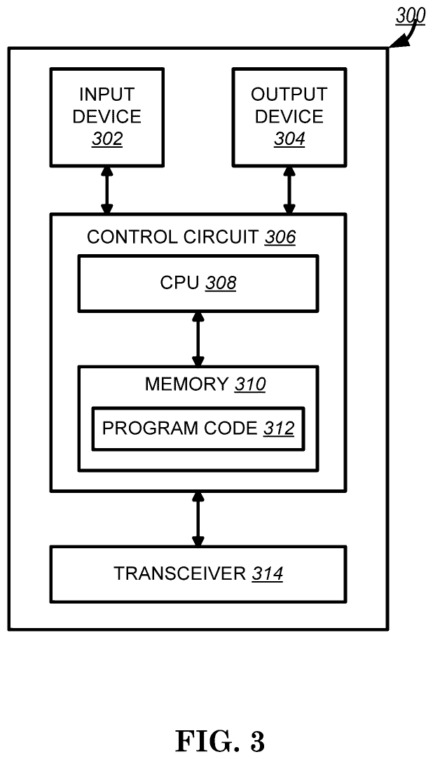

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

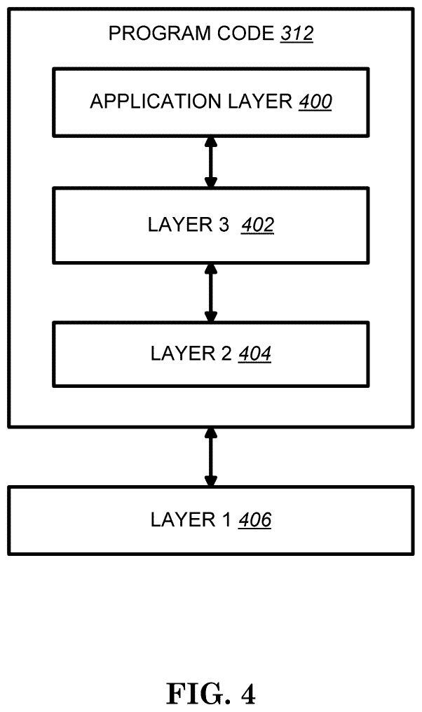

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

Frame structure used in New RAT (NR) for 5G, to accommodate various type of requirement (as discussed in 3GPP TS 38.211 V15.7.0) for time and frequency resource, e.g. from ultra-low latency (˜0.5 ms) to delay-tolerant traffic for Machine-Type Communication (MTC), from high peak rate for eMBB to very low data rate for MTC. An important focus of this study is low latency aspect, e.g. short Transmission Time Interval (TTI), while other aspect of mixing/adapting different TTIs can also be considered in the study. In addition to diverse services and requirements, forward compatibility is an important consideration in initial NR frame structure design as not all features of NR would be included in the beginning phase/release.

More details of NR frame structure, channel and numerology design are discussed and provided below in 3GPP TS 38.211:

### 4 Frame Structure and Physical Resources

### 4.3.1 Frames and Subframes

Downlink and uplink transmissions are organized into frames with T_{f}=(ΔfₘₐₓN_{f}+/100)·T_{c}=10 ms duration, each consisting of ten subframes of T_{sf}=(ΔfₘₐₓN_{f}/1000)·T_{c}=1 ms duration. The number of consecutive OFDM symbols per subframe is N_{symb}^{subframe,μ}=N_{symb}^{slot}Nₛₗₒₜ^{subframe,μ}. Each frame is divided into two equally-sized half-frames of five subframes each with half-frame 0 consisting of subframes 0-4 and half-frame 1 consisting of subframes 5-9.

There is one set of frames in the uplink and one set of frames in the downlink on a carrier. Uplink frame number i for transmission from the UE shall start T_{TA}=(N_{TA}+N_{TAoffset})T_{c} before the start of the corresponding downlink frame at the UE where N_{TAoffset} is given by [5, TS 38.213].

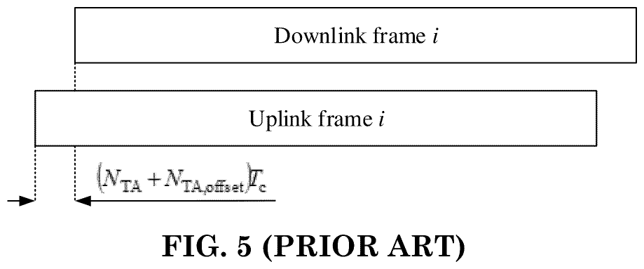

### [FIG. 4.3.1-1 of 3GPP TS 38.211 V15.7.0, Entitled “Uplink-Downlink Timing Relation”, is Reproduced as FIG. 5]

### 4.3.2 Slots

For subcarrier spacing configuration u, slots are numbered nₛ^{μ}∈{0, . . . , Nₛₗₒₜ^{subframe,μ}−1} in increasing order within a subframe and n_{s,f}^{μ}∈{0, . . . , Nₛₗₒₜ^{frame,μ}−1} in increasing order within a frame. There are N_{symb}^{slot} consecutive OFDM symbols in a slot where N_{symb}^{slot} depends on the cyclic prefix as given by Tables 4.3.2-1 and 4.3.2-2. The start of slot nₛ^{μ} in a subframe is aligned in time with the start of OFDM symbol nₛ^{μ} N_{symb}^{slot} in the same subframe.

OFDM symbols in a slot can be classified as ‘downlink’, ‘flexible’, or ‘uplink’. Signaling of slot formats is described in subclause 11.1 of [5, TS 38.213].

In a slot in a downlink frame, the UE shall assume that downlink transmissions only occur in ‘downlink’ or ‘flexible’ symbols.

In a slot in an uplink frame, the UE shall only transmit in ‘uplink’ or ‘flexible’ symbols.

[ . . . ]

### 4.4.3 Resource Elements

Each element in the resource grid for antenna port p and subcarrier spacing configuration u is called a resource element and is uniquely identified by (k, l)_{p,u} where k is the index in the frequency domain and l refers to the symbol position in the time domain relative to some reference point. Resource element (k, l)_{p,u} corresponds to a physical resource and the complex value a_{k,l}^{(p,μ)}. When there is no risk for confusion, or no particular antenna port or subcarrier spacing is specified, the indices p and u may be dropped, resulting in a_{k,l}^{(p)} or a_{k,l}.

### 4.4.4 Resource Blocks

### 4.4.4.4 Physical Resource Blocks

Physical resource blocks for subcarrier configuration u are defined within a bandwidth part and numbered from 0 to N_{BWP,i}^{size,μ}−1 where i is the number of the bandwidth part. The relation between the physical resource block n_{PRB}^{μ} in bandwidth part i and the common resource block n_{PRB}^{μ} is given by

$${n}_{CRB}^{μ} = {n}_{P R B}^{μ} + {N}_{B WP , i}^{s t a rt , μ}$$

where N_{BWP,i}^{start,μ} is the common resource block where bandwidth part starts relative to common resource block 0. When there is no risk for confusion the index μ may be dropped.

### 4.4.4.5 Virtual Resource Blocks

Virtual resource blocks are defined within a bandwidth part and numbered from 0 to N_{BWP,i}^{size,μ}−1 where i is the number of the bandwidth part.

### 4.4.5 Bandwidth Part

A bandwidth part is a subset of contiguous common resource blocks defined in subclause 4.4.4.3 for a given numerology u; in bandwidth part i on a given carrier. The starting position N_{BWP,i}^{start,μ} and the number of resource blocks N_{BWP,i}^{size,μ} in a bandwidth part shall fulfil N_{grid,x}^{start,μ}, N_{grid,x}^{size,μ} and N_{grid,x}^{start,μ}<N_{BWP,i}^{start,μ}+N_{BWP,i}^{size,μ}≤N_{grid,x}^{start,μ}, N_{grid,x}^{size,μ}, respectively. Configuration of a bandwidth part is described in clause 12 of [5, TS 38.213].

A UE can be configured with up to four bandwidth parts in the downlink with a single downlink bandwidth part being active at a given time. The UE is not expected to receive PDSCH, PDCCH, or CSI-RS (except for RRM) outside an active bandwidth part.

A UE can be configured with up to four bandwidth parts in the uplink with a single uplink bandwidth part being active at a given time. If a UE is configured with a supplementary uplink, the UE can in addition be configured with up to four bandwidth parts in the supplementary uplink with a single supplementary uplink bandwidth part being active at a given time. The UE shall not transmit PUSCH or PUCCH outside an active bandwidth part. For an active cell, the UE shall not transmit SRS outside an active bandwidth part.

Unless otherwise noted, the description in this specification applies to each of the bandwidth parts. When there is no risk of confusion, the index u may be dropped from N_{BWP,i}^{start,μ}, N_{BWP,i}^{size,μ}, N_{grid,x}^{start,μ}, N_{grid,x}^{size,μ}.

### 4.5 Carrier Aggregation

Transmissions in multiple cells can be aggregated. Unless otherwise noted, the description in this specification applies to each of the serving cells.

Random access procedure is introduced for several purposes, e.g. to acquire UL (Uplink) synchronization (e.g. UL TA (Timing Advance)), to ask for UL grants resource(s), to recover form beam failure and so on. Random access procedure could be categorized into contention based random access procedure and non-contention based random access procedure. For non-contention based random access procedure, a dedicated preamble (as well as dedicated PRACH (Physical Random Access Channel) resource) is assigned to the UE so that gNB could identify the UE transmitting the preamble via preamble detection/reception. For requesting system information, a dedicated preamble could be allocated for requesting a (specific) SI/SIB(s) (e.g. SIB2). The dedicated preamble could be utilized by all UEs requesting the SI/SIB(s). (e.g. for requesting system information, identifying the UE is not necessary). The UE would then monitor random access response from the base station. The non-contention based random access random access procedure would be considered as complete successfully when/if the random access response to the transmitted preamble is received. On the other hand, for contention-based random access procedure, a preamble is randomly selected from a set of available preambles (e.g. which may depends on a purpose or situation or UE which initiates the random access procedure). After transmitting the random access preamble, the UE could monitor the corresponding random access response. After successfully receiving the random access response, the UE would transmit a Msg 3 (which could be used to identified the UE). After transmitting Msg3, the UE would monitor a contention resolution (e.g. Msg 4). If contention resolution for the UE is successfully received, the UE would consider the random access procedure is successfully finished.

More details related to random access procedure are discussed and provided below in 3GPP TS 38.213, TS 38.321, and TS 38.331. In particular, 3GPP TS 38.213 states:

### 8 Random Access Procedure

Prior to initiation of the physical random access procedure, Layer 1 receives from higher layers a set of SS/PBCH block indexes and provides to higher layers a corresponding set of RSRP measurements.

Prior to initiation of the physical random access procedure, Layer 1 may receive from higher layers an indication to perform a Type-1 random access procedure, as described in clauses 8.1 through 8.4, or a Type-2 random access procedure as described in clauses 8.1 through 8.2A. Prior to initiation of the physical random access procedure, Layer 1 receives the following information from the higher layers:
Configuration of physical random access channel (PRACH) transmission parameters (PRACH preamble format, time resources, and frequency resources for PRACH transmission).
Parameters for determining the root sequences and their cyclic shifts in the PRACH preamble sequence set (index to logical root sequence table, cyclic shift (N(s), and set type (unrestricted, restricted set A, or restricted set B)).

From the physical layer perspective, the Type-1 L1 random access procedure includes the transmission of random access preamble (Msg1) in a PRACH, random access response (RAR) message with a PDCCH/PDSCH (Msg2), and when applicable, the transmission of a PUSCH scheduled by a RAR UL grant, and PDSCH for contention resolution.

From the physical layer perspective, the Type-2 L1 random access procedure includes the transmission of random access preamble in a PRACH and of a PUSCH (MsgA) and the reception of a RAR message with a PDCCH/PDSCH (MsgB), and when applicable, the transmission of a PUSCH scheduled by a fallback RAR UL grant, and PDSCH for contention resolution.

If a random access procedure is initiated by a PDCCH order to the UE, a PRACH transmission is with a same SCS as a PRACH transmission initiated by higher layers.

If a UE is configured with two UL carriers for a serving cell and the UE detects a PDCCH order, the UE uses the UL/SUL indicator field value from the detected PDCCH order to determine the UL carrier for the corresponding PRACH transmission.

### 8.1 Random Access Preamble

Physical random access procedure for a UE is triggered upon request of a PRACH transmission by higher layers or by a PDCCH order for a cell. A configuration by higher layers for a PRACH transmission includes the following:
A configuration for PRACH transmission on the cell [4, TS 38.211].
A preamble index, a preamble SCS, PPRACH, target, a corresponding RA-RNTI when applicable [11, TS 38.321], and a PRACH resource for the cell.
A number of N_{preamble}^{rep}>1 preamble repetitions for the PRACH transmission if the UE would transmit the PRACH with repetitions.

A UE transmits a PRACH on a cell using the selected PRACH format with transmission power P_{PRACH, b,f,c}(i), as described in clause 7.4, on the indicated PRACH resource or on determined N_{preamble}^{rep} resources in case of N_{preamble}^{rep} preamble repetitions.

[ . . . ]

### 8.2 Random Access Response-Type-1 Random Access Procedure

In response to a PRACH transmission, a UE attempts to detect a DCI format 1_0 with CRC scrambled by a corresponding RA-RNTI during a window controlled by higher layers [11, TS 38.321]. The window starts at the first symbol of the earliest CORESET the UE is configured to receive PDCCH for Type1-PDCCH CSS set, as defined in clause 10.1, that is at least one symbol, after the last symbol of the last PRACH occasion corresponding to the PRACH transmission, where the symbol duration corresponds to the SCS for Type1-PDCCH CSS set as defined in clause 10.1. If N_{TA,adj}^{UE} or N_{TA,adj}^{common}, as defined in [4, TS 38.211], is not zero, the window starts after an additional T_{TA}+k_{mac} msec where T_{TA} is defined in [4, TS 38.211] and k_{mac} is provided by k_{mac} or k_{mac}=0 if k_{mac} is not provided. The length of the window in number of slots, based on the SCS for Type1-PDCCH CSS set, is provided by ra-ResponseWindow.

If the UE detects the DCI format 1_0 with CRC scrambled by the corresponding RA-RNTI and LSBs of a SFN field in the DCI format 1_0, if included and applicable, are same as corresponding LSBs of the SFN where the UE transmitted PRACH, and the UE receives a transport block in a corresponding PDSCH within the window, the UE passes the transport block to higher layers. The higher layers parse the transport block for a random access preamble identity (RAPID) associated with the PRACH transmission. If the higher layers identify the RAPID in RAR message(s) of the transport block, the higher layers indicate an uplink grant to the physical layer. This is referred to as random access response (RAR) UL grant in the physical layer. If the UE does not detect the DCI format 1_0 with CRC scrambled by the corresponding RA-RNTI within the window, or if the UE detects the DCI format 1_0 with CRC scrambled by the corresponding RA-RNTI within the window and LSBs of a SFN field in the DCI format 1_0, if included and applicable, are not same as corresponding LSBs of the SFN where the UE transmitted PRACH, or if the UE does not correctly receive the transport block in the corresponding PDSCH within the window, or if the higher layers do not identify the RAPID associated with the PRACH transmission from the UE, the higher layers can indicate to the physical layer to transmit a PRACH. If requested by higher layers, the UE shall be ready to transmit a PRACH no later than N_{T,1}+0.75 msec after the last symbol of the window, or the last symbol of the PDSCH reception, where N_{T,1} is a time duration of N₁ symbols corresponding to a PDSCH processing time for UE processing capability 1 assuming μ corresponds to the smallest SCS configuration among the SCS configurations for the PDCCH carrying the DCI format 1_0, the corresponding PDSCH when additional PDSCH DM-RS is configured, and the corresponding PRACH. For μ=0, the UE assumes N_{1,0}=14 [6, TS 38.214]. For a PRACH transmission using 1.25 kHz or 5 kHz SCS, the UE determines N₁ assuming SCS configuration μ=0.

If the UE detects a DCI format 1_0 with CRC scrambled by the corresponding RA-RNTI and LSBs of a SFN field in the DCI format 1_0, if included and applicable, are same as corresponding LSBs of the SFN where the UE transmitted the PRACH, and the UE receives a transport block in a corresponding PDSCH, the UE may assume same DM-RS antenna port quasi co-location properties, as described in [6, TS 38.214], as for a SS/PBCH block or a CSI-RS resource the UE used for PRACH association, as described in clause 8.1, regardless of whether or not the UE is provided TCI-State for the CORESET where the UE receives the PDCCH with the DCI format 1_0. If the UE attempts to detect the DCI format 1_0 with CRC scrambled by the corresponding RA-RNTI in response to a PRACH transmission initiated by a PDCCH order that triggers a contention-free random access procedure for the SpCell [11, TS 38.321], the UE may assume that the PDCCH that includes the DCI format 1_0 and the PDCCH order have same DM-RS antenna port quasi co-location properties. If the UE attempts to detect the DCI format 1_0 with CRC scrambled by the corresponding RA-RNTI in response to a PRACH transmission initiated by a PDCCH order that triggers a contention-free random access procedure for a secondary cell or if the PDCCH order is from a cell other than the serving cell, the UE may assume the DM-RS antenna port quasi co-location properties of the CORESET associated with the Type1-PDCCH CSS set for receiving the PDCCH that includes the DCI format 1_0 and the PDSCH scheduled by the DCI format 1_0.

A RAR UL grant schedules a PUSCH transmission from the UE. The contents of the RAR UL grant, starting with the MSB and ending with the LSB, are given in Table 8.2-1.

If the value of the frequency hopping flag is 0, the UE transmits the PUSCH without frequency hopping; otherwise, the UE transmits the PUSCH with frequency hopping.

The UE determines the MCS of the PUSCH transmission from the first sixteen indexes of the applicable MCS index table for PUSCH as described in [6, TS 38.214].

The TPC command value δ_{msg2,b,f,c} is used for setting the power of the PUSCH transmission, as described in clause 7.1.1, and is interpreted according to Table 8.2-2.

The CSI request field is reserved.

The ChannelAccess-CPext field indicates a channel access type and CP extension for operation with shared spectrum channel access [15, TS 37.213] in FR1 as defined in Table 7.3.1.1.1-4 in [5, TS 38.212] or Table 7.3.1.1.1-4A in [5, TS 38.212] if channelAccessMode=“semiStatic” is provided. The ChannelAccess-CPext field indicates a channel access type for operation with shared spectrum channel access [15, TS 37.213] in FR2-2 as defined in Table 7.3.1.1.1-4B in [5, TS 38.212] if ChannelAccessMode2-r17 is provided.

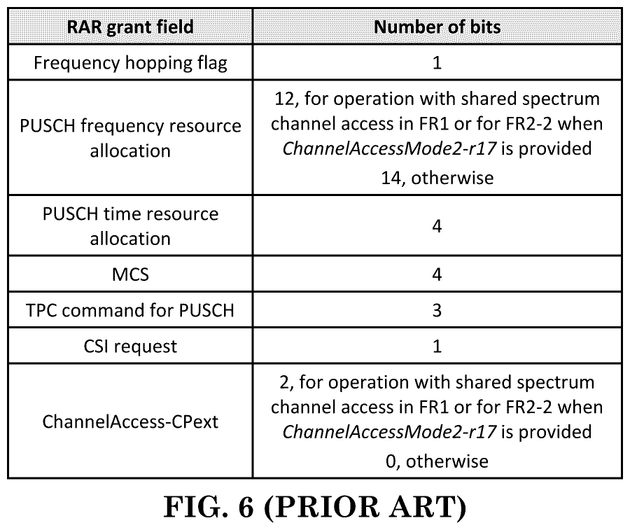

### [Table 8.2-1 of 3GPP TS 38.213 V18.0.0, Entitled “Random Access Response Grant Content Field Size”, is Reproduced as FIG. 6]

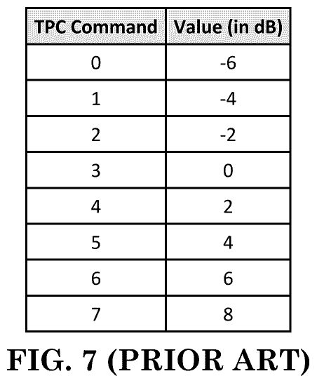

### [Table 8.2-2 of 3GPP TS 38.213 V18.0.0, Entitled “TPC Command &Msg2,b,f,c for PUSCH”, is Reproduced as FIG. 7]

Unless the UE is configured a SCS, the UE receives subsequent PDSCH using same SCS as for the PDSCH reception providing the RAR message.

If the UE does not detect the DCI format 1_0 with CRC scrambled by the corresponding RA-RNTI within the window, or if the UE detects the DCI format 1_0 with CRC scrambled by the corresponding RA-RNTI within the window and the LSBs of a SFN field in the DCI format 1_0, if included and applicable, are not same as corresponding LSBs of the SFN where the UE transmitted the PRACH, or the UE does not correctly receive a corresponding transport block within the window, the UE procedure is as described in [11, TS 38.321]. [ . . . ]

### 13 UE Procedure for Monitoring Type0-PDCCH CSS Sets

If during cell search a UE determines from MIB that a CORESET for Type0-PDCCH CSS set is present, as described in clause 4.1, the UE determines a number of consecutive resource blocks and a number of consecutive symbols for the CORESET of the Type0-PDCCH CSS set from controlResourceSetZero in pdcch-ConfigSIB1, as described in Tables 13-0 through 13-10, for operation without shared spectrum channel access in FR1 and FR2-1, or as described in Tables 13-1A and 13-4A for operation with shared spectrum channel access in FR1, or as described in Table 13-10A for FR2-2, and determines PDCCH monitoring occasions from searchSpaceZero in pdcch-ConfigSIB1, included in MIB, as described in Tables 13-11 through 13-15A. SFN_{c} and n_{c} are the SFN and slot index within a frame of the CORESET based on SCS of the CORESET and SFN_{SSB,i} and n_{SSB,i} are the SFN and slot index based on SCS of the CORESET, respectively, where the SS/PBCH block with index i overlaps in time with system frame SFN_{SSB,i} and slot N_{SSB,i}. The symbols of the CORESET associated with pdcch-ConfigSIB1 in MIB or with searchSpaceSIB1 in PDCCH-ConfigCommon have normal cyclic prefix. In Table 13-0, configurations with index 0 to 9 are applicable when an associated SS/PBCH block is located according to Table 5.4.3.3-2 in [8-1, TS 38.101-1], configurations with index 10 to 11 are applicable when an associated SS/PBCH block is located according to NOTE 12 of Table 5.4.3.3-1 in [8-1, TS 38.101-1], and non-interleaved CCE-to-REG mapping applies for configurations with index 6 to 9. In Table 13-1, the associated SS/PBCH block is not located according to NOTE 12 of Table 5.4.3.3-1 in [8-1, TS 38.101-1].

For operation with shared spectrum channel access in FR2-2 and for operation without shared spectrum channel access, a UE assumes that the offset in Tables 13-0 through 13-10A is defined with respect to the SCS of the CORESET for Type0-PDCCH CSS set from the smallest RB index of the CORESET for Type0-PDCCH CSS set to the smallest RB index of the common RB overlapping with the first RB of the corresponding SS/PBCH block, after puncturing if any [4, TS 38.211]. The SCS of the CORESET for Type0-PDCCH CSS set is provided by subCarrierSpacingCommon for FR1 and FR2-1 and same as the SCS of the corresponding SS/PBCH block for FR2-2. In Tables 13-7, 13-8, and 13-10, k_{SSB} is defined in [4, TS 38.211].

For operation with shared spectrum channel access in FR1, a UE determines an offset from a smallest RB index of the CORESET for Type0-PDCCH CSS set to a smallest RB index of the common RB overlapping with a first RB of the corresponding SS/PBCH block
according to the offset in Table 13-1A or Table 13-4A, if the frequency position of the SS/PBCH block corresponds to the GSCN of a synchronization raster entry as defined in [8-1, TS 38.101-1], and
according to a sum of a first offset and a second offset if the frequency position of the SS/PBCH block is provided by ssbFrequency in a measurement configuration associated with a reporting configuration providing reportCGI and does not correspond to the GSCN of a synchronization raster entry as defined in [8-1, TS 38.101-1], where
   the first offset is provided in Table 13-1A or Table 13-4A, and
   the second offset is determined as the offset from a smallest RB index of the common RB overlapping with the first RB of the SS/PBCH block indicated in the measurement configuration to a smallest RB index of the common RB overlapping with the first RB of a SS/PBCH block hypothetically located at the GSCN of a synchronization raster entry, where the single synchronization raster entry is located in the same channel as the SS/PBCH block used for the shared spectrum channel access procedure, as described in [15, TS 37.213]
where the offsets are defined with respect to the SCS of the CORESET for Type0-PDCCH CSS set that is same as the SCS of the corresponding SS/PBCH block.

For operation without shared spectrum channel access and for the SS/PBCH block and CORESET multiplexing pattern 1, a UE monitors PDCCH in the Type0-PDCCH CSS set over two slots. For SS/PBCH block with index i, the UE determines an index of slot n₀ as n₀=(O·2^{μ}+└i·M┘)mod Nₛₗₒₜ^{frame,μ} that is in a frame with system frame number (SFN) SFN_{C} satisfying SFN_{c} mod 2=0 if └(O·2^{μ}+└i·M┘)/Nₛₗₒₜ^{frame,μ} mod 2=0, or in a frame with SFN satisfying SFN_{c} mod 2=1 if └(O·2^{μ}+└i·M┘)/Nₛₗₒₜ^{frame,μ} mod 2=1, where μ∈{0,1,2,3,5,6} based on the SCS for PDCCH receptions in the CORESET [4, TS 38.211].
For μ∈{0, 1, 2, 3} and for a SS/PBCH block index i, the two slots including the associated Type0-PDCCH monitoring occasions are slots n₀ and n₀+1. M, O, and the index of the first symbol of the CORESET in slots n₀ and n₀+1 are provided by Table 13-11 and Table 13-12.
For μ=5 and for a SS/PBCH block index i, the two slots including the associated Type0-PDCCH monitoring occasions are slots n₀ and n₀+4. M, O, and the index of the first symbol of the CORESET in slots n₀ and n₀+4 are provided by Table 13-12A, where X=1.25.
For μ=6 and for a SS/PBCH block index i, the two slots including the associated Type0-PDCCH monitoring occasions are slots n₀ and n₀+8. M, O, and the index of the first symbol of the CORESET in slots n₀ and n₀+8 are provided by Table 13-12A, where X=0.625.

For operation with shared spectrum channel access and for the SS/PBCH block and CORESET multiplexing pattern 1, a UE monitors PDCCH in the Type0-PDCCH CSS set over slots that include Type0-PDCCH monitoring occasions associated with SS/PBCH blocks that are quasi co-located with the SS/PBCH block that provides a CORESET for Type0-PDCCH CSS set with respect to average gain, quasi co-location ‘typeA’ and ‘typeD’ properties, when applicable [6, TS 38.214]. For a candidate SS/PBCH block index l̅, where 0≤l̅≤L̅ₘₐₓ−1, two slots include the associated Type0-PDCCH monitoring occasions. The UE determines an index of slot n₀ as n₀=(O·2^{μ}+└l̅·M┘) mod Nₛₗₒₜ^{frame,μ} slot that is in a frame with system frame number (SFN) SFN_{c} satisfying SFN_{c} mod 2=0 if └(O·2^{μ}+└l̅·M┘)/Nₛₗₒₜ^{frame,μ}┘ mod 2=0, or in a frame with SFN satisfying SFN_{c} mod 2=1 if └(O·2^{μ}+└l̅·M┘)/Nₛₗₒₜ^{frame,μ}┘ mod 2=1 where μ∈{0, 1,3,5,6} based on the SCS for PDCCH receptions in the CORESET [4, TS 38.211].
For μ∈{0, 1} and for a candidate SS/PBCH block index l̅, the two slots including the associated Type0-PDCCH monitoring occasions are slots n₀ and n₀+1. M, O, and the index of the first symbol of the CORESET in slots n₀ and n₀+1 are provided by Table 13-11. The UE does not expect to be configured with M=½, or with M=2, when N_{SSB}^{QCL}=1.
For μ=3 and for a candidate SS/PBCH block index l̅, the two slots including the associated Type0-PDCCH monitoring occasions are slots n₀ and n₀+1. M, O, and the index of the first symbol of the CORESET in slots n₀ and n₀+1 are provided by Table 13-12.
For μ=5 and for a candidate SS/PBCH block index l̅, the two slots including the associated Type0-PDCCH monitoring occasions are slots n₀ and n₀+4. M, O, and the index of the first symbol of the CORESET in slots n₀ and n₀+4 are provided by Table 13-12A, where X=1.25.
For μ=6 and for a candidate SS/PBCH block index l̅, the two slots including the associated Type0-PDCCH monitoring occasions are slots n₀ and n₀+8. M, O, and the index of the first symbol of the CORESET in slots n₀ and n₀+8 are provided by Table 13-12A, where X=0.625.

For operation without shared spectrum channel access and for the SS/PBCH block and CORESET multiplexing patterns 2 and 3, a UE monitors PDCCH in the Type0-PDCCH CSS set over one slot with Type0-PDCCH CSS set periodicity equal to the periodicity of SS/PBCH block. For a SS/PBCH block with index i, the UE determines the slot index n_{c} and SFN_{c} based on parameters provided by Tables 13-13 through 13-15A.

For operation with shared spectrum channel access and for SS/PBCH block and CORESET multiplexing pattern 3, a UE monitors PDCCH in the Type0-PDCCH CSS set over slots that include Type0-PDCCH monitoring occasions associated with SS/PBCH blocks that are quasi co-located with the SS/PBCH block that provides a CORESET for Type0-PDCCH CSS set with respect to average gain, quasi co-location ‘typeA’ and ‘typeD’ properties, when applicable. For a candidate SS/PBCH block index t, where 0≤l̅≤L̅ₘₐₓ−1, the periodicity of the slot including the associated Type0-PDCCH monitoring occasion is same as the periodicity of the candidate SS/PBCH block, and the UE determines the slot index n_{c} and SFN, based on parameters provided by Tables 13-15 and 13-15A, where i is replaced by l̅ for operation with shared spectrum channel access in FR2-2.

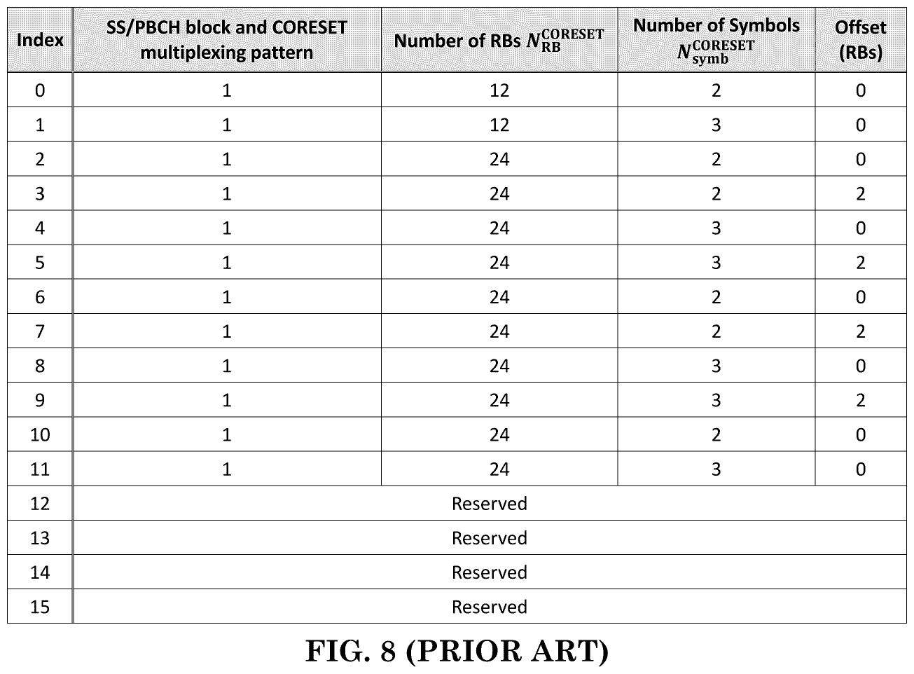

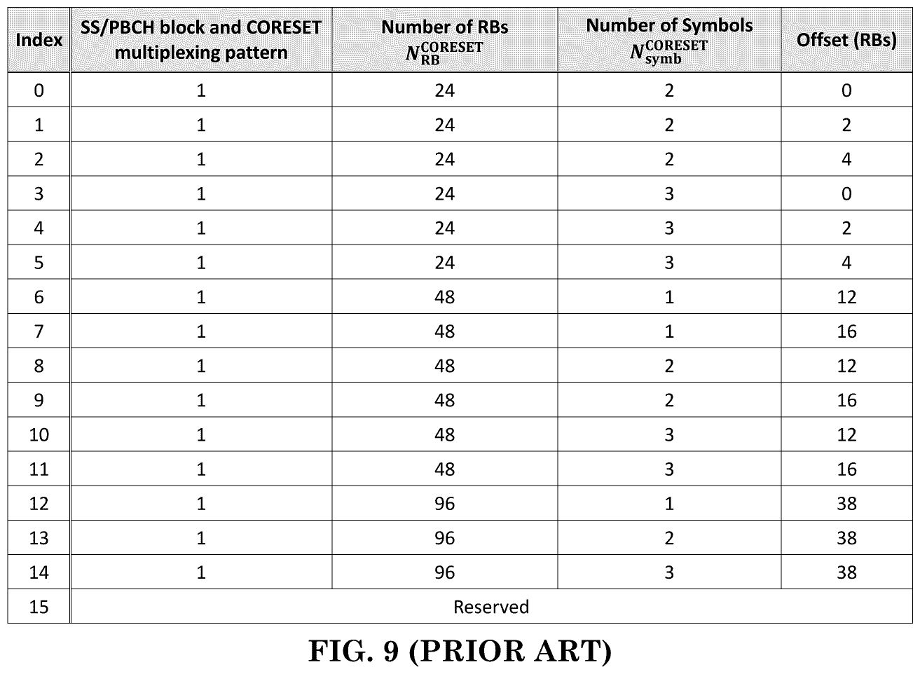

For the SS/PBCH block and CORESET multiplexing patterns 2 and 3, if the active DL BWP is the initial DL BWP, the UE is expected to be able to perform radio link monitoring, as described in clause 5, and measurements for radio resource management [10, TS 38.133] using a SS/PBCH block that provides a CORESET for Type0-PDCCH CSS set.

[Table 13-0 of 3GPP TS 38.213 V18.0.0, entitled “Set of resource blocks and slot symbols of CORESET for Type0-PDCCH search space set when {SS/PBCH block, PDCCH} SCS is {15, 15} kHz for frequency bands with minimum channel bandwidth 3 MHz and channel bandwidth 3 MHz or 5 MHz”, is reproduced as FIG. 8]
[Table 13-1 of 3GPP TS 38.213 V18.0.0, entitled “Set of resource blocks and slot symbols of CORESET for Type0-PDCCH search space set when {SS/PBCH block, PDCCH} SCS is {15, 15} kHz for frequency bands with minimum channel bandwidth 5 MHz or 10 MHz or with minimum channel bandwidth 3 MHz and channel bandwidth larger than 3 MHz”, is reproduced as FIG. 9]

If a UE detects a SS/PBCH block and determines that a CORESET for Type0-PDCCH CSS set is not present, and for 24≤k_{SSB}≤29 for FR1 or for 12≤k_{SSB}≤13 for FR2, the UE may determine the nearest (in the corresponding frequency direction) global synchronization channel number (GSCN) of a second SS/PBCH block having a CORESET for an associated Type0-PDCCH CSS set as N_{GSCN}^{Reference}+N_{GSCN}^{Size}·N_{GSCN}^{Offset}·N_{GSCN}^{Reference} is the GSCN of the first SS/PBCH block, N_{GSCN}^{Size}=1 in FR1 and FR2-1, N_{GSCN}^{Size}=3 in FR2-2, and N_{GSCN}^{Offset} is a GSCN offset provided by Table 13-16 for FR1 and Table 13-17 for FR2. If the UE detects the second SS/PBCH block and the second SS/PBCH block does not provide a CORESET for Type0-PDCCH CSS set, as described in clause 4.1, the UE may ignore the information related to GSCN of SS/PBCH block locations for performing cell search.

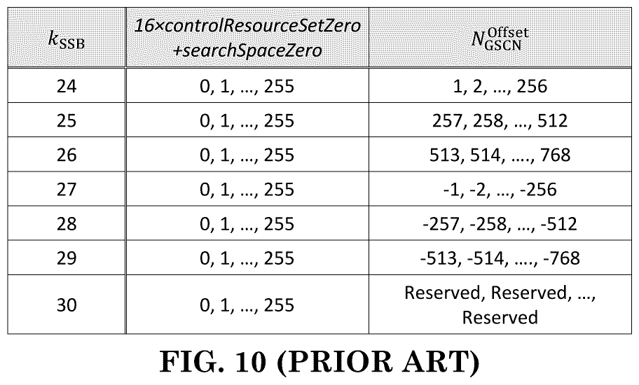

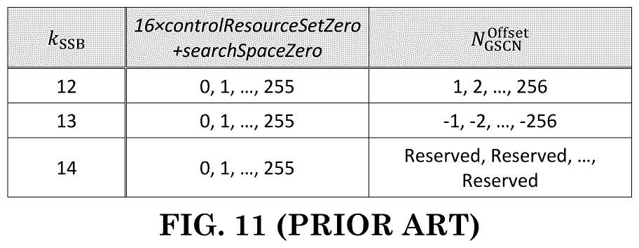

If a UE detects a SS/PBCH block and determines that a CORESET for Type0-PDCCH CSS set is not present, and for k_{SSB}=31 for FR1 or for k_{SSB}=15 for FR2, the UE determines that there is no SS/PBCH block having an associated Type0-PDCCH CSS set within a GSCN range [N_{GSCN}^{Reference}−N_{GSCN}^{Start}, N_{GSCN}^{Reference}+N_{GSCN}^{End}]. N_{GSCN}^{Start} and N_{GSCN}^{End} are respectively determined by controlResourceSetZero and searchSpaceZero in pdcch-ConfigSIB1. If the GSCN range is [N_{GSCN}^{Reference}, N_{GSCN}^{Reference}], the UE determines that there is no information for a second SS/PBCH block with a CORESET for an associated Type0-PDCCH CSS set on the detected SS/PBCH block. If a UE does not detect any SS/PBCH block providing a CORESET for Type0-PDCCH CSS set, as described in clause 4.1, within a time period determined by the UE, the UE may ignore the information related to GSCN of SS/PBCH locations in performing cell search.

[Table 13-16 of 3GPP TS 38.213 V18.0.0, Entitled “Mapping Between the Combination of k_{SSB} and controlResourceSetZero and searchSpaceZero in Pdcch-ConfigSIB1 to N_{GSCN}^{Offset} for FR1”, is Reproduced as FIG. 10]
[Table 13-17 of 3GPP TS 38.213 V18.0.0, entitled “Mapping between the combination of k_{SSB} and controlResourceSetZero and searchSpaceZero in pdcch-ConfigSIB1 to N_{GSCN}^{Offset} for FR2”, is reproduced as FIG. 11]

Furthermore, 3GPP 38.321 States:

### 5.1.2 Random Access Resource Selection

If the selected RA_TYPE is set to 4-stepRA, the MAC entity shall:
. . .
1> else if the Random Access procedure was initiated for SI request (as specified in TS 38.331 [5]); and
1> if the Random Access Resources for SI request have been explicitly provided by RRC:
   2> if at least one of the SSBs with SS-RSRP above rsrp-ThresholdSSB is available:
      3> select an SSB with SS-RSRP above rsrp-ThresholdSSB.
   2> else:
      3> select any SSB.
   2> select a Random Access Preamble corresponding to the selected SSB, from the Random Access Preamble(s) determined according to ra-PreambleStartIndex as specified in TS 38.331 [5];
   2> set the PREAMBLE_INDEX to selected Random Access Preamble.
1> else (i.e. for the contention-based Random Access preamble selection):
   2> if at least one of the SSBs with SS-RSRP above rsrp-ThresholdSSB is available:
      3> select an SSB with SS-RSRP above rsrp-ThresholdSSB.
   2> else:
      3> select any SSB.
[ . . . ]

### 5.1.4 Random Access Response Reception

Once the Random Access Preamble is transmitted and regardless of the possible occurrence of a measurement gap, the MAC entity shall:
1> if the contention-free Random Access Preamble for beam failure recovery request was transmitted by the MAC entity:
   2> if the contention-free Random Access Preamble for beam failure recovery request was transmitted on a non-terrestrial network:
      3> start the ra-ResponseWindow configured in BeamFailureRecoveryConfig at the PDCCH occasion as specified in TS 38.213 [6].
   2> else:
      3> start the ra-ResponseWindow configured in BeamFailureRecoveryConfig at the first PDCCH occasion as specified in TS 38.213 [6] from the end of the Random Access Preamble transmission.
   2> monitor for a PDCCH transmission on the search space indicated by recoverySearchSpaceld of the SpCell identified by the C-RNTI while ra-ResponseWindow is running.
1> else:
   2> if the Random Access Preamble was transmitted on a non-terrestrial network:
      3> start the ra-ResponseWindow configured in RACH-ConfigCommon at the PDCCH occasion as specified in TS 38.213 [6].
   2> else:
      3> start the ra-ResponseWindow configured in RACH-ConfigCommon at the first PDCCH occasion as specified in TS 38.213 [6] from the end of the Random Access Preamble transmission.
   2> monitor the PDCCH of the SpCell for Random Access Response(s) identified by the RA-RNTI while the ra-ResponseWindow is running.
1> if notification of a reception of a PDCCH transmission on the search space indicated by recoverySearchSpaceld is received from lower layers on the Serving Cell where the preamble was transmitted; and
1> if PDCCH transmission is addressed to the C-RNTI; and
1> if the contention-free Random Access Preamble for beam failure recovery request was transmitted by the MAC entity:
   2> consider the Random Access procedure successfully completed.
1> else if a valid (as specified in TS 38.213 [6]) downlink assignment has been received on the PDCCH for the RA-RNTI and the received TB is successfully decoded:
   2> if the Random Access Response contains a MAC subPDU with Backoff Indicator:
      3> set the PREAMBLE_BACKOFF to value of the BI field of the MAC subPDU using Table 7.2-1, multiplied with SCALING_FACTOR_BI.
   2> else:
      3> set the PREAMBLE_BACKOFF to 0 ms.
   2> if the Random Access Response contains a MAC subPDU with Random Access Preamble identifier corresponding to the transmitted PREAMBLE_INDEX (see clause 5.1.3):
      3> consider this Random Access Response reception successful.
   2> if the Random Access Response reception is considered successful:
      3> if the Random Access Response includes a MAC subPDU with RAPID only:
         4> consider this Random Access procedure successfully completed;
         4> indicate the reception of an acknowledgement for SI request to upper layers. 3> else:
         4> apply the following actions for the Serving Cell where the Random Access Preamble was transmitted:
         5> process the received Timing Advance Command (see clause 5.2);
         5> indicate the preambleReceivedTargetPower and the amount of power ramping applied to the latest Random Access Preamble transmission to lower layers (i.e. (PREAMBLE_POWER_RAMPING_COUNTER−1)×PREAMBLE_POWER_RAMPING_STEP);
         5> if the Random Access procedure for an SCell is performed on uplink carrier where pusch-Config is not configured:
         6> ignore the received UL grant.
         5> else:
         6> process the received UL grant value and indicate it to the lower layers.
         4> if the Random Access Preamble was not selected by the MAC entity among the contention-based Random Access Preamble(s):
         5> consider the Random Access procedure successfully completed.
         4> else:
         5> set the TEMPORARY_C-RNTI to the value received in the Random Access Response;
         5> if this is the first successfully received Random Access Response within this Random Access procedure:
         6> if the transmission is not being made for the CCCH logical channel:
         7> indicate to the Multiplexing and assembly entity to include a C-RNTI MAC CE in the subsequent uplink transmission.
         6> if the Random Access procedure was initiated for SpCell beam failure recovery and spCell-BFR-CBRA with value true is configured:
         7> if there is at least one Serving Cell of this MAC entity configured with two BFD-RS sets:
         8> indicate to the Multiplexing and assembly entity to include an Enhanced BFR MAC CE or a Truncated Enhanced BFR MAC CE in the subsequent uplink transmission.
         7> else:
         8> indicate to the Multiplexing and assembly entity to include a BFR MAC CE or a Truncated BFR MAC CE in the subsequent uplink transmission.
         6> else if the Random Access procedure was initiated for beam failure recovery of both BFD-RS sets of SpCell:
         7> indicate to the Multiplexing and assembly entity to include an Enhanced BFR MAC CE or a Truncated Enhanced BFR MAC CE in the subsequent uplink transmission.
         6> obtain the MAC PDU to transmit from the Multiplexing and assembly entity and store it in the Msg3 buffer.

NOTE: If within a Random Access procedure, an uplink grant provided in the Random Access Response for the same group of contention-based Random Access Preambles has a different size than the first uplink grant allocated during that Random Access procedure, the UE behavior is not defined.
1> if ra-ResponseWindow configured in BeamFailureRecoveryConfig expires and if a PDCCH transmission on the search space indicated by recoverySearchSpaceld addressed to the C-RNTI has not been received on the Serving Cell where the preamble was transmitted; or
1> if ra-ResponseWindow configured in RACH-ConfigCommon expires, and if the Random Access Response containing Random Access Preamble identifiers that matches the transmitted PREAMBLE_INDEX has not been received:
   2> consider the Random Access Response reception not successful;
   2> increment PREAMBLE_TRANSMISSION_COUNTER by 1;
   2> if PREAMBLE_TRANSMISSION_COUNTER=preamble TransMax+1:
      3> if the Random Access Preamble is transmitted on the SpCell:
         4> indicate a Random Access problem to upper layers;
         4> if this Random Access procedure was triggered for SI request:
         5> consider the Random Access procedure unsuccessfully completed.
      3> else if the Random Access Preamble is transmitted on an SCell:
         4> consider the Random Access procedure unsuccessfully completed.
   2> if the Random Access procedure is not completed:
      3> select a random backoff time according to a uniform distribution between 0 and the PREAMBLE_BACKOFF;
      3> if the criteria (as defined in clause 5.1.2) to select contention-free Random Access Resources is met during the backoff time:
         4> perform the Random Access Resource selection procedure (see clause 5.1.2).
      3> else if the Random Access procedure for an SCell is performed on uplink carrier where pusch-Config is not configured:
         4> delay the subsequent Random Access transmission until the Random Access Procedure is triggered by a PDCCH order with the same ra-PreambleIndex, ra-ssb-OccasionMaskIndex, and UL/SUL indicator TS 38.212 [9].
      3> else:
         4> perform the Random Access Resource selection procedure (see clause 5.1.2) after the backoff time.

The MAC entity may stop ra-ResponseWindow (and hence monitoring for Random Access Response(s)) after successful reception of a Random Access Response containing Random Access Preamble identifiers that matches the transmitted PREAMBLE_INDEX. HARQ operation is not applicable to the Random Access Response reception.
[ . . . ]

In addition, 3GPP TS 38.331 states:

### 5.2.2.3.3 Request for on Demand System Information

The UE shall, while SDT procedure is not ongoing:
1> if SIB1 includes si-SchedulingInfo containing si-RequestConfigSUL and criteria to select supplementary uplink as defined in TS 38.321 [3], clause 5.1.1 is met:
   2> trigger the lower layer to initiate the Random Access procedure on supplementary uplink in accordance with TS 38.321 [3] using the PRACH preamble(s) and PRACH resource(s) in si-RequestConfigSUL corresponding to the SI message(s) that the UE requires to operate within the cell, and for which si-BroadcastStatus is set to notBroadcasting;
   2> if acknowledgement for SI request is received from lower layers:
      3> acquire the requested SI message(s) as defined in clause 5.2.2.3.2, immediately;
1> else if the UE is a RedCap UE and if initialUplinkBWP-RedCap is configured in UplinkConfigCommonSIB and if SIB1 includes si-SchedulingInfo containing si-RequestConfigRedCap and criteria to select normal uplink as defined in TS 38.321 [3], clause 5.1.1 is met:
   2> trigger the lower layer to initiate the Random Access procedure on normal uplink in accordance with TS 38.321 [3] using the PRACH preamble(s) and PRACH resource(s) in si-RequestConfigRedcap corresponding to the SI message(s) that the UE requires to operate within the cell, and for which si-BroadcastStatus is set to notBroadcasting;
   2> if acknowledgement for SI request is received from lower layers:
      3> acquire the requested SI message(s) as defined in clause 5.2.2.3.2, immediately; 1> else:
   2> if the UE is not a RedCap UE and if SIB1 includes si-SchedulingInfo containing si-RequestConfig and criteria to select normal uplink as defined in TS 38.321 [3], clause 5.1.1 is met; or
   2> if the UE is a RedCap UE and if initialUplinkBWP-RedCap is not configured in UplinkConfigCommonSIB and if SIB1 includes si-SchedulingInfo containing si-RequestConfig and criteria to select normal uplink as defined in TS 38.321 [3], clause 5.1.1 is met:
      3> trigger the lower layer to initiate the Random Access procedure on normal uplink in accordance with TS 38.321 [3] using the PRACH preamble(s) and PRACH resource(s) in si-RequestConfig corresponding to the SI message(s) that the UE requires to operate within the cell, and for which si-BroadcastStatus is set to notBroadcasting; 3> if acknowledgement for SI request is received from lower layers:
         4> acquire the requested SI message(s) as defined in clause 5.2.2.3.2, immediately;
   2> else:
      3> apply the default L1 parameter values as specified in corresponding physical layer specifications except for the parameters for which values are provided in SIB1;
      3> apply the default MAC Cell Group configuration as specified in 9.2.2;
      3> apply the timeAlignmentTimerCommon included in SIB1;
      3> apply the CCCH configuration as specified in 9.1.1.2;
      3> initiate transmission of the RRCSystemInfoRequest message with rrcSystemInfoRequest in accordance with 5.2.2.3.4;
      3> if acknowledgement for RRCSystemInfoRequest message with rrcSystemInfoRequest is received from lower layers:
         4> acquire the requested SI message(s) as defined in clause 5.2.2.3.2, immediately;
1> if cell reselection occurs while waiting for the acknowledgment for SI request from lower layers:
   2> reset MAC;
   2> if SI request is based on RRCSystemInfoRequest message with rrcSystemInfoRequest: 3> release RLC entity for SRB0.

NOTE: After RACH failure for SI request it is up to UE implementation when to retry the SI request.

[ . . . ]
SI-RequestConfig

The IE SI-RequestConfig contains configuration for Msg1 based SI request.

SI-RequestConfig information element

-- ASN1START

-- TAG-SI-REQUESTCONFIG-START

| | |
|---|---|
| SI-RequestConfig ::= | SEQUENCE { |
| rach-OccasionsSI | SEQUENCE { |
| rach-ConfigSI | RACH-ConfigGeneric, |
| ssb-perRACH-Occasion | ENUMERATED {oneEighth, |

oneFourth, oneHalf, one, two, four, eight, sixteen}

| | |
|---|---|
| } | |
| OPTIONAL, -- Need R | |
| si-RequestPeriod | ENUMERATED {one, two, four, six, |

eight, ten, twelve, sixteen} OPTIONAL, -- Need R

| | |
|---|---|
| si-RequestResources | SEQUENCE (SIZE (1..maxSI-Message)) |
| | OF SI-RequestResources |
| } | |
| SI-RequestResources ::= | SEQUENCE { |
| ra-PreambleStartIndex | INTEGER (0..63), |
| ra-AssociationPeriodIndex | INTEGER (0..15) |
| OPTIONAL, -- Need R | |
| ra-ssb-OccassionMaskIndex | INTEGER (0..15) |
| OPTIONAL, -- Need R | |
| } | |

-- TAG-SI-REQUESTCONFIG-STOP

-- ASN1STOP

Network energy saving is introduced to save power from base station perspective. Energy could be saved by reducing the transmission/reception occasion(s) in time domain. For example, during a period of time that no transmission/reception is performed, the corresponding hardware component(s) could be turn off completely (e.g. go to deep sleep) so that power consumption is reduced. Therefore, from power saving perspective, it would be more preferred to perform/finish transmission/reception within a certain period (e.g. a condensed period) and turn off transmission reception outside the certain period (e.g. for a longer period of time). There could be a trade-off that larger latency would be induced since the opportunities to transmit/receive is reduced. Common signal could be a source of an always turn-on signal irrespective of whether there is ongoing traffic. For example, common signal (e.g. SSB (Synchronization Signal Block), SS (Solution Set)/PBCH (Physical Broadcast Channel) block, SIB1, SIB (System Information Block), paging, PRACH (Physical Random Access Channel)) is broadcasted and/or could be used for all UEs in the cell, e.g. including UE not yet access the cell. Therefore, reducing the transmission/reception of common signal would become an attractive solution to network energy saving. More details regarding network energy saving is discussed and provided below in 3GPP RP-234065:

### 3 Justification

Network energy saving is of great importance for environmental sustainability, to reduce environmental impact (greenhouse gas emissions), and for operational cost savings. As 5G is becoming pervasive across industries and geographical areas, handling more advanced services and applications requiring very high data rates (e.g. XR), networks are being denser, use more antennas, larger bandwidths and more frequency bands. The environmental impact of 5G needs to stay under control, and novel solutions to improve network energy savings need to be developed.

Energy consumption has become a key part of the operators' OPEX. According to the report from GSMA [1], the energy cost on mobile networks accounts for ˜23% of the total operator cost. Most of the energy consumption comes from the radio access network and in particular from the Active Antenna Unit (AAU), with data centres and fibre transport accounting for a smaller share. The power consumption of a radio access can be split into two parts: the dynamic part which is only consumed when data transmission/reception is ongoing, and the static part which is consumed all the time to maintain the necessary operation of the radio access devices, even when the data transmission/reception is not on-going.

During the study in the SI phase [2], the network energy consumption model for the base station (BS) was defined including the reference configurations for FR1 TDD/FDD and FR2, the deep/light/micro sleep power states with corresponding relative power, transition time and energy consumption among different power states based on two types of BS categories, and the scaling rules for the active DL/UL power states considering BS power split by a static part of power and a dynamic part of power with the latter part reflecting the dynamic power consumption with respect to transmission/reception resource configurations in time, frequency, spatial and power domains. In addition, evaluation methodology and assumptions were achieved to study and evaluate the network energy saving gains for potential techniques with respect to other KPI including UPT, access delay, UE power consumption, etc.

Based on the agreed BS energy consumption model, and the evaluation methodology and assumptions, potential network energy saving techniques in various domains were evaluated with respect to the energy saving gains and the corresponding performance impact considering the above KPIs. The studied techniques are classified into time, frequency, spatial and power domains, and the technical descriptions as well as the legacy UE and specification impacts are summarized in the technical report [2]. The techniques in time and frequency domains mainly aim to reduce the power consumption for dynamic part by trying to shutdown more symbols on one or more carriers to achieve BS micro sleep, and even the static power part by enlarging the interval between the contiguous active transmission/reception occasions to achieve BS light/deep sleep. The techniques in spatial and power domains mainly aim to reduce the power consumption of the TRX chains and PAs by trying to shutdown more spatial elements and/or reduce transmission power/power spectrum density, or increase the PA efficiency. As shown in Section 7 in TR 38.864 [2], some of the studied techniques are beneficial for network energy savings.

The Rel-18 work item on network energy savings for NR led to the specification of some of the techniques that were found beneficial in the study, primarily for RRC Connected, user specific signals and channels, and low load scenarios. The techniques specified in Rel-18 include SSB-less SCell operation for inter-band CA for FR1 and co-located cells, enhancement on cell DTX/DRX mechanism including the alignment of cell DTX/DRX and UE DRX in RRC_CONNECTED mode, inter-node information exchange on cell DTX/DRX, techniques in spatial and power domains to enable efficient adaptation of spatial elements as well as efficient adaptation of power offset values between PDSCH and CSI-RS, as well as mechanisms to prevent legacy UEs camping on cells adopting the Rel-18 NES techniques, CHO procedure enhancement(s), and inter-node beam activation and enhancements on restricting paging in a limited area, and the corresponding RRM/RF core requirements.

Some other techniques also found to be beneficial in the study were not yet specified in Rel-18. This Rel-19 work item aims to specify further network energy savings targeting the beneficial techniques studied in Rel-18, but yet unspecified, including on-demand SSB and on-demand SIB1 transmissions, as well as adaptation of common signal/channel transmissions.

[1] GSMA, 5G energy efficiencies: Green is the new black, https://data.gsmaintelligence.com/api-web/v2/research-file-download?id=54165956&file=241120-5G-energy.pdf [2] 3GPP TR 38.864 V18.1.0, Study on network energy savings for NR.

### 4 Objective

### 4.1 Objective of SI or Core Part WI or Testing Part WI

The objectives of the work item are the following:
1. Specify procedures and signaling method(s) to support on-demand SSB SCell operation for UEs in connected mode configured with CA, for both intra-/inter-band CA. [RAN1/2/3/4]
   Specify triggering method(s) (select from UE uplink wake-up-signal using an existing signal/channel, cell on/off indication via backhaul, Scell activation/deactivation signaling).
   Note1: On-demand SSB transmission can be used by UE for at least SCell time/frequency synchronization, L1/L3 measurements and SCell activation, and is supported for FR1 and FR2 in non-shared spectrum.
2. Study procedures and signaling method(s) to support on-demand SIB1 for UEs in idle/inactive mode, including: [RAN1/2/3]
   Triggering method by uplink wake-up-signal using an existing signal/channel.
   Wake-up-signal configuration provisioning to UE
      Note: No modification of SSB will be discussed under this objective
   Information exchange between gNBs at least for the configuration of wake-up signal, if necessary.
   Checkpoint for normative work in RAN #105
3. Specify adaptation of common signal/channel transmissions. [RAN1/2/3/4]
   Adaptation of SSB in time domain, e.g. adapting periodicity
   Adaptation of PRACH in time domain
   Study adaptation of PRACH in spatial domain, e.g. non-uniform PRACH resources per SSB, and specify if found beneficial
      This study is to be done in 2Q′2024 only
   Adaptation of paging occasions including confining the paging occasions in the time domain
      Note: there shall be no paging latency increase
   Note: there shall be no negative impact to legacy UEs, unless significant benefits are shown
4. Specify the corresponding core requirements, for the above features [RAN4].

As shown and discussed above, UE may send a request to request SIB1. The base station may take into account several factors in deciding whether to stay in power saving status/mode or to be back to normal operation. Currently SIB1 is provided with the same periodicity as Synchronization Signal Block (SSB) (and corresponding monitoring occasion is derived from SSB) and SIB1 is provided with all beam direction and/or all SSB. For the sake of power saving, it would be more efficient if “back to normal” is scalable. In other words, it is better to still save some power/energy if SIB1 does not required to be provided with all existing time occasion and/or SSB and/or beam direction while instead only provided a subset of them or with a lower periodicity.

A first general concept of this invention is that base station indicates SIB1 is provided on which beam and/or SIB1 associated with which SSB is provided. The indication could be indicated together with indication of whether base station would provide SIB1, e.g. within Random Access Response (RAR) or SSB. The indication could be indicated separately from indication of whether base station would provide SIB1, e.g. within RAR or SSB. Each SSB could indicate, e.g. in Master Information Block (MIB), whether SIB1 associated with the SSB is provided or not. Each SSB could indicate, e.g. in MIB, whether SIB1(s) associated with other SSB(s) is provided or not. Each SSB could indicate, e.g. in MIB, whether SIB1(s) is provided or not for all SSB.

For example, there could be a bitmap indicating whether SIB1 associated with each SSB is provided or not. Prior to initiate a random access procedure to request SIB1, the UE would determine whether SIB1 is provided by corresponding SSB(s) or not. Corresponding SSB(s) could be SSB with the best quality or with the strongest received power. Corresponding SSB(s) could be the SSB(s) which could be received by the UE. Corresponding SSB(s) could be the SSB to be selected for random access procedure. When/if SIB1 associated with corresponding SSB(s) is provided, the UE does not initiate random access procedure to request SIB1. When/if SIB1 associated with corresponding SSB(s) is not provided, the UE initiates random access procedure to request SIB1.

A second general concept of this invention is that a time domain pattern for monitoring SIB1 is indicated to the UE. There could be multiple time domain patterns configured for SIB1, and base station indicates to the UE which one is applicable. One of the time domain patterns could be the one used when on demand SIB1 is disable. One of the time domain patterns could be provided or configured or indicated by MIB. The other(s) of the time domain pattern could be provided or indicated or configured by SIB (e.g. SIB1) or dedicated Radio Resource Control (RRC) message. The indication could be indicated together with the indication of whether base station would provide SIB1, e.g. within RAR or SSB. The indication could be indicated separately from the indication of whether base station would provide SIB1, e.g. within RAR or SSB.

The time domain pattern could be a search space. The UE could be configured with multiple search spaces for SIB1. One of search space is indicated or configured by SSB. The other of the search spaces could be configured or indicated by SIB (e.g. SIB1) or dedicated RRC message. After initiating request for SIB1, the UE would receive indication regarding which of the time domain patterns and/or which of the search space is applied for SIB1.

The indication could indicate whether the search space and/or the time domain pattern indicated in SSB is used or not. The indication regarding which time domain pattern and/or which search space is applied could be indicated in RAR. The indication regarding which time domain pattern and/or which search space is applicable could be indicated in RAR in response to preamble requesting SIB1. The indication regarding which time domain pattern and/or which search space is applicable could be indicated in SSB. The indication regarding which time domain pattern and/or which search space could be present when/if base station would provide SIB1. The indication regarding which time domain pattern and/or which search space could be encoded jointly with the indication of whether base station would provide SIB1.

After receiving indication regarding which time domain pattern and/or which search space, the UE receives or monitors SIB1 and/or Physical Downlink Control Channel (PDCCH) indicating SIB1 according to the indicated time domain pattern and/or search space. The time domain pattern could be a periodicity and or an offset. The time domain pattern could be a periodicity for/of SIB1 and or an offset for/of SIB1.

A periodicity for/of SIB1 and or an offset for/of SIB I could be indicated with respective to SSB. Periodicity for/of SIB1 could be different from periodicity for/of SSB. Periodicity for/of SIB1 could be a multiple of a periodicity for/of SSB (e.g. two times or four times or eight times). The indication could indicate the multiple. For example, if periodicity of SSB is X, the indication could indicate 1, 2, 4, 8, which indicates periodicity of SIB1 is X, 2*X, 4*X, 8*X respectively. The offset value could be used to indicate the SIB1 is present for which SSB period. When SIB1 periodicity is 4*X, there is (one) SIB1 occasion associated with one SSB out of four periodic SSBs or out of 4 SSB periods. And the offset value could indicate SIB1 is available for which one of the four SSBs, e.g. whether the first one, the second one, or the fourth one.

Note that the first one could be determined based on a SSB in a predefined time occasion, e.g. a SSB in SFN 0 or a SSB closest to SFN 0. For example, the first one could be the SSB whose time domain distance to the SSB in a predefined time occasion is a multiple of 4*X. The first one could be the SSB in System Frame Number (SFN) Y and the SSB in a predefined time occasion is in SFN Z, where Y mod 4*X is equal to Z mod 4*X. The offset value could be a predetermined value, e.g. 0 or the first one (which means indication of offset value is not required). The time domain pattern could be a bitmap indicating SIB1 associated with SSB in which SSB period is provided.

A third general concept of this invention is to indicate whether base station would provide SIB1 or not and/or whether the base station would wake up or not in RAR. For example, there could be 1 bit in RAR indicates SIB1 would be provided (e.g. in the following or in a near future) or not and/or whether the base station would wake up or not. The random access procedure could be completed successfully irrespective of whether base station provides RAR or not. If/when RAR indicates SIB1 would be provided, the UE would attempt to receive/monitor SIB1. If/when RAR indicates SIB1 would be provided in a serving cell, the UE would attempt to access the serving cell. If/when RAR indicates SIB I would be provided in a serving cell, the UE would initiate another random access procedure (e.g. a second random access procedure) to access the serving cell. If/when RAR indicates SIB I would not be provided in a serving cell, the UE could determine to access another serving cell. If/when RAR indicates SIB1 would not be provided in a serving cell, the UE could perform cell reselection to camp/access a serving cell which provides SIB1.

A fourth general concept of this invention is to indicate whether base station would provide SIB1 or not and/or whether the base station would wake up or not in a SSB (e.g. SS/PBCH block). For example, there could be 1 bit in MIB of SSB indicates SIB1 would be provided (e.g. in the following or in a near future) or not and/or whether the base station would wake up or not. A UE could initiate a random access procedure to request SIB1. A UE could initiate a random access procedure to request SIB1 if/when SSB indicates SIB1 is (currently) not provided and/or the base station is sleeping (e.g. not wake up).

After receiving RAR for the random access procedure, the UE would acquire SSB to check whether base station would provide SIB1 or not and/or whether the base station would wake up or not. The SSB could be an SSB in a next SSB occasion or an SSB in an SSB occasion indicated by the RAR. The SSB could be an SSB selected during the random access procedure. If/when SSB indicates SIB1 would be provided, the UE would attempt to receive/monitor SIB1. If/when SSB indicates SIB1 would be provided in a serving cell, the UE would attempt to access the serving cell. If/when SSB indicates SIB1 would be provided in a serving cell, the UE would initiate another random access procedure (e.g. a second random access procedure) to access the serving cell. If/when SSB indicates SIB1 would not be provided in a serving cell, the UE could determine to access another serving cell. If/when SSB indicates SIB1 would not be provided in a serving cell, the UE could perform cell reselection to camp/access a serving cell which provides SIB1.

In one embodiment, a UE initiates a random access procedure to request a first system information. The first system information could be SIB1. The UE initiates a random access procedure to request a first system information when/if the first system information is (e.g. currently) not provided (e.g. in a serving cell and or in a Primary Cell (PCell) of a base station). The UE camps on or selects the serving cell. The UE initiates a random access procedure to request a first system information when/if an SSB/MIB indicates the first system information is (e.g. currently) not provided (e.g. in a serving cell and or in a PCell of a base station). The SSB/MIB indicating the first system information is (e.g. currently) not provided indicates a search space for SIB1.

After the random access procedure is initiated, the UE transmits a preamble on a serving cell to a base station. The UE receives a random access response from the base station. The random access response indicates the preamble or the request is received successfully. After receiving the random access response, the UE would receive or acquire SSB/MIB. The UE would receive or acquire SSB/MIB in response to reception of the random access response. The SSB could be a next SSB. The SSB could have a same index as selected in the random access response. The SSB could be indicated by the random access response. The SSB occasion could be indicated by the random access response. The SSB and/or MIB indicates whether the first system information would be provided (e.g. in the following) or not. The SSB and/or MIB indicates whether the request is accepted or rejected. The SSB and/or MIB indicates whether the request is accepted or not. The SSB and/or MIB indicates whether the base station or the serving cell would wake up or not. The SSB and/or MIB indicates whether the base station or the serving cell would wake up or remain sleep.

The UE determines whether to acquire/receive/monitor the first system information (or PDCCH scheduling the first system information) or not based on indication in the SSB and/or MIB. The UE acquires or attempts to receive the first system information (e.g. on the serving cell) when/if the SSB and/or MIB indicates the first system information would be provided. The UE acquires or attempts to receives the first system information (e.g. on the serving cell) when/if the SSB and/or MIB indicates the request is accepted. The UE acquires or attempts to receive the first system information (e.g. on the serving cell) when/if the SSB and/or MIB indicates the base station or the serving cell would wake up. The UE does not acquire or does not attempt to receive the first system information (e.g. on the serving cell) when/if the SSB and/or MIB indicates the first system information would not be provided (in the following). The UE does not acquire or does not attempt to receives the first system information (e.g. on the serving cell) when/if the SSB and/or MIB indicates the request is rejected or not accepted. The UE does not acquire or does not attempt to receives the first system information (e.g. on the serving cell) when/if the SSB and/or MIB indicates the base station or the serving cell would remain sleep or would not wake up.

The UE determines whether to access the serving cell or not based on indication in the SSB and/or MIB. (to access the serving cell could mean to set up a (RRC) connection to the serving cell). The UE accesses the serving cell when/if the SSB and/or MIB indicates the first system information would be provided. The UE accesses the serving cell when/if the SSB and/or MIB indicates the request is accepted. The UE accesses the serving cell when/if the SSB and/or MIB indicates the base station or the serving cell would wake up. The UE does not access the serving cell when/if the SSB and/or MIB indicates the first system information would not be provided (in the following). The UE does not access the serving cell when/if the SSB and/or MIB indicates the request is rejected or not accepted. The UE does not access the serving cell when/if the SSB and/or MIB indicates the base station or the serving cell would remain sleep or would not wake up. The UE accesses another serving cell (different form the serving cell) when/if the SSB and/or MIB indicates the first system information would not be provided (in the following). The UE accesses another serving cell (different form the serving cell) when/if the SSB and/or MIB indicates the request is rejected or not accepted. The UE accesses another serving cell (different form the serving cell) when/if the SSB and/or MIB indicates the base station or the serving cell would remain sleep or would not wake up.

The UE performs cell selection or cell reselection when/if the SSB and/or MIB indicates the first system information would not be provided (in the following). The UE performs cell selection or cell reselection when/if the SSB and/or MIB indicates the request is rejected or not accepted. The UE performs cell selection or cell reselection when/if the SSB and/or MIB indicates the base station or the serving cell would remain sleep or would not wake up.

The SSB and/or MIB indicates search space for SIB1. The UE initiates a second random access procedure for requesting a second system information. The second system information is system information other than SIB1. The second system information is OSI. The second system information is system information scheduled by SIB1. The UE acquires/receives/monitors the second system information (or PDCCH scheduling the second system information) as long as the second random access response is received. The UE does not acquire/receive SSB/MIB in response to reception of the second random access response. The UE does not determine whether to acquire/receive/monitor the second system information (or PDCCH scheduling the second system information) or not based on indication in the SSB/MIB. The UE does not determine whether to access the serving cell or not based on indication in the SSB/MIB. The UE does not determine whether to access another serving cell or not based on indication in the SSB/MIB. The UE does not determine whether to perform cell reselection or not based on indication in the SSB/MIB.

In another embodiment, a base station receives or detects a preamble from a UE. The preamble is for requesting a first system information. The first system information could be SIB1. The base station receives or detects a preamble from a UE when/if the first system information is (e.g. currently) not provided (e.g. in a serving cell and or in a PCell of a base station). The base station receives or detects a preamble from a UE when/if an SSB/MIB indicates the first system information is (e.g. currently) not provided (e.g. in a serving cell and or in a PCell of a base station). The SSB/MIB indicating the first system information is (e.g. currently) not provided indicates a search space for SIB1.

After transmitting the random access response, the base station transmits an SSB/MIB. The SSB could be a next SSB. The SSB could have a same index which associated with the PRACH resource. The SSB could be indicated by the random access response. The SSB occasion could be indicated by the random access response. The SSB and/or MIB indicates whether the first system information would be provided (e.g. in the following) or not. The SSB and/or MIB indicates whether the request is accepted or rejected. The SSB and/or MIB indicates whether the request is accepted or not. The SSB and/or MIB indicates whether the base station or the serving cell would wake up or not. The SSB and/or MIB indicates whether the base station or the serving cell would wake up or remain sleep. The indication is used by the UE to determine whether to acquire/receive/monitor the first system information (or PDCCH scheduling the first system information) or not. The indication is used by the UE to determine whether to access the serving cell or not. The indication is used by the UE to determine whether to access the serving cell or another serving cell. The indication is used by the UE to determine whether to perform cell selection/reselection or not.

The base station receives or detects a second preamble from a UE for requesting a second system information. The second system information is system information other than SIB1. The second system information is OSI. The second system information is system information scheduled by SIB1. The UE acquires/receives/monitors the second system information (or PDCCH scheduling the second system information) as long as the second random access response is received. The UE does not acquire/receive SSB/MIB in response to reception of the second random access response. The SSB and/or MIB indicates whether the second system information would be provided (e.g. in the following) or not.

In another embodiment, a UE initiates a random access procedure to request a first system information. The first system information could be SIB1. The first system information could be MIB. The first system information could be MIB for another serving cell, e.g. Secondary Cell (SCell). The UE initiates a random access procedure to request a first system information when/if the first system information is (e.g. currently) not provided (e.g. in a serving cell and or in a Primary Cell (PCell) of a base station).

After the random access procedure is initiated, the UE transmits a preamble on a serving cell to a base station. The UE receive a random access response from the base station. The random access response indicates whether the first system information would be provided (e.g. in the following) or not. The random access response indicates whether the request is accepted or rejected. The random access response indicates whether the request is accepted or not. The random access response indicates whether the base station or the serving cell would wake up or not. The random access response indicates whether the base station or the serving cell would wake up or remain sleep.

The UE determines whether to acquire/receive/monitor the first system information (or PDCCH scheduling the first system information) or not based on indication in the random access response. The UE acquires or attempts to receive the first system information (e.g. on the serving cell) when/if the random access response indicates the first system information would be provided. The UE acquires or attempts to receives the first system information (e.g. on the serving cell) when/if the random access response indicates the request is accepted. The UE acquires or attempts to receive the first system information (e.g. on the serving cell) when/if the random access response indicates the base station or the serving cell would wake up. The UE does not acquire or does not attempt to receive the first system information (e.g. on the serving cell) when/if the random access response indicates the first system information would not be provided (in the following). The UE does not acquire or does not attempt to receives the first system information (e.g. on the serving cell) when/if the random access response indicates the request is rejected or not accepted. The UE does not acquire or does not attempt to receives the first system information (e.g. on the serving cell) when/if the random access response indicates the base station or the serving cell would remain sleep or would not wake up.

The UE determines whether to access the serving cell or not based on indication in the random access response. (to access the serving cell could mean to set up a (RRC) connection to the serving cell). The UE accesses the serving cell when/if the random access response indicates the first system information would be provided. The UE accesses the serving cell when/if the random access response indicates the request is accepted. The UE accesses the serving cell when/if the random access response indicates the base station or the serving cell would wake up. The UE does not access the serving cell when/if the random access response indicates the first system information would not be provided (in the following). The UE does not access the serving cell when/if the random access response indicates the request is rejected or not accepted. The UE does not access the serving cell when/if the random access response indicates the base station or the serving cell would remain sleep or would not wake up. The UE accesses another serving cell (different form the serving cell) when/if the random access response indicates the first system information would not be provided (in the following). The UE accesses another serving cell (different form the serving cell) when/if the random access response indicates the request is rejected or not accepted. The UE accesses another serving cell (different form the serving cell) when/if the random access response indicates the base station or the serving cell would remain sleep or would not wake up.

The UE performs cell selection or cell reselection when/if the random access response indicates the first system information would not be provided (in the following). The UE performs cell selection or cell reselection when/if the random access response indicates the request is rejected or not accepted. The UE performs cell selection or cell reselection when/if the random access response indicates the base station or the serving cell would remain sleep or would not wake up.

The UE initiates a second random access procedure for requesting a second system information. The second system information is system information other than SIB1. The second system information is OSI. The second system information is system information scheduled by SIB1. The UE transmits a (second) preamble to requesting the second system information.

The UE receives a (second) random access response from the base station in response to the (second) preamble. The second random access response indicates the (second) preamble or the request is received successfully. The second random access response does not indicate whether the second system information would be provided (e.g. in the following) or not. The second random access response does not indicate whether the request is accepted or rejected. The second random access response does not indicate whether the request is accepted or not. The second random access response does not indicate whether the base station or the serving cell would wake up or not. The second random access response does not indicate whether the base station or the serving cell would wake up or remain sleep. Note that “does not indicate” could mean the corresponding indication is absent.

The UE acquires/receives/monitors the second system information (or PDCCH scheduling the second system information) as long as the second random access response is received. The UE does not determine whether to acquire/receive/monitor the second system information (or PDCCH scheduling the second system information) or not based on indication in the second random access response. The UE does not determine whether to access the serving cell or not based on indication in the second random access response. The UE does not determine whether to access another serving cell or not based on indication in the second random access response. The UE does not determine whether to perform cell reselection or not based on indication in the second random access response.

In another embodiment, a base station receives or detects a preamble from a UE. The preamble is for requesting a first system information. The first system information could be SIB1. The base station receives or detects a preamble from a UE when/if the first system information is (e.g. currently) not provided (e.g. in a serving cell and or in a PCell of a base station).

The base station transmits a random access response to the UE. The random access response indicates whether the first system information would be provided (e.g. in the following) or not. The random access response indicates whether the request is accepted or rejected. The random access response indicates whether the request is accepted or not. The random access response indicates whether the base station or the serving cell would wake up or not. The random access response indicates whether the base station or the serving cell would wake up or remain sleep. The indication in the random access response is used by the UE to determine whether to acquire/receive/monitor the first system information (or PDCCH scheduling the first system information) or not. The indication in the random access response is used by the UE to determine whether to perform cell selection/reselection or not.

The base station receives or detects a second preamble from the UE. The preamble is for requesting a second system information. The second system information is system information other than SIB1. The second system information is OSI. The second system information is system information scheduled by SIB1. The base station transmits a (second) random access response to the UE in response to the (second) preamble. The second random access response indicate the (second) preamble or the request is received successfully. The second random access response does not indicate whether the second system information would be provided (e.g. in the following) or not. The second random access response does not indicate whether the request is accepted or rejected. The second random access response does not indicate whether the request is accepted or not. The second random access response does not indicate whether the base station or the serving cell would wake up or not. The second random access response does not indicate whether the base station or the serving cell would wake up or remain sleep. Note that “does not indicate” could mean the corresponding indication is absent.

The UE receives an indication regarding a first system information is provided on which beam and/or a first system information associated with which SSB (index), e.g. SSB 0, SSB1, . . . , is provided. The first system information could be SIB1. The first system information could be MIB. The first system information could be MIB of another serving cell (e.g. SCell).

The UE receives the indication regarding the first system information is provided on which beam and/or the first system information associated with which SSB (index) is provided after requesting the first system information. The indication is indicated in an RAR. The indication is indicated in an SSB. The indication could be indicated together and/or jointly with an indication of whether the first system information would be provided or not. The indication could be indicated together and/or jointly with an indication of whether the base station would wake up or not. The indication could be indicated together and/or jointly with an indication of whether request is accepted or not. The indication could indicate whether the first system information is provided on a (specific/corresponding) beam or not and/or whether the first system information associated with a (specific/corresponding) SSB is provided or not. The (specific/corresponding) beam and/or the (specific/corresponding) SSB could be a beam and/or an SSB utilized and/or selected during a random access procedure (e.g. to request the first system information). The (specific/corresponding) beam and/or the (specific/corresponding) SSB could be a beam and/or an SSB associated with a Physical Random Access Channel (PRACH) utilized/selected in a random access procedure (e.g. to request the first system information).

The indication could indicate whether the first system information is provided on each beam of a plurality of beams or not and/or whether the first system information associated with each SSB of a plurality of SSBs is provided or not. For example, the indication could be a bitmap where each bit associated with one beam and/or one SSB. The indication could be a bitmap where each bit associated with a set of one or more beam(s) and/or a set of one or more SSB(s). The indication could indicate whether the first system information is provided on a plurality of beams or not and/or whether the first system information associated with a plurality of SSBs is provided or not. The plurality of beams and/or the plurality of SSBs could be all beams and/or all SSBs of a cell. The plurality of beams and/or the plurality of SSBs could be a subset of beams and/or a subset of SSBs of a cell.

Prior to initiate a random access procedure to request the first information, the UE could determine whether the first system information is provided by corresponding SSB(s) or not. Corresponding SSB(s) could be SSB with the best quality or with the strongest received power. Corresponding SSB(s) could be SSB(s) which could be received by the UE. Corresponding SSB(s) could be SSB to be selected for random access procedure. When/if the first system information associated with corresponding SSB(s) is provided, the UE does not initiate random access procedure to request the first system information. When/if the first system information associated with corresponding SSB(s) is not provided, the UE initiate random access procedure to request the first system information.

The base station transmits an indication regarding a first system information is provided on which beam and/or a first system information associated with which SSB (index), e.g. SSB 0, SSB1, . . . , is provided. The first system information could be SIB1. The first system information could be MIB. The first system information could be MIB of another serving cell (e.g. SCell).

The base station transmits the indication regarding the first system information is provided on which beam and/or the first system information associated with which SSB (index) is provided for UE to determine whether to request the first system information. The indication is indicated in an RAR. The indication is indicated in an SSB. The indication could be indicated together and/or jointly with an indication of whether the first system information would be provided or not. The indication could be indicated together and/or jointly with an indication of whether the base station would wake up or not. The indication could be indicated together and/or jointly with an indication of whether request is accepted or not. The indication could indicate whether the first system information is provided on a (specific/corresponding) beam or not and/or whether the first system information associated with a (specific/corresponding) SSB is provided or not. The (specific/corresponding) beam and/or the (specific/corresponding) SSB could be a beam and/or an SSB utilized and/or selected during a random access procedure (e.g. to request the first system information). The (specific/corresponding) beam and/or the (specific/corresponding) SSB could be a beam and/or an SSB associated with a PRACH utilized/selected in a random access procedure (e.g. to request the first system information).

The indication could indicate whether the first system information is provided on each beam of a plurality of beams or not and/or whether the first system information associated with each SSB of a plurality of SSBs is provided or not. For example, the indication could be a bitmap where each bit associated with one beam and/or one SSB. The indication could be a bitmap where each bit associated with a set of one or more beam(s) and/or a set of one or more SSB(s). The indication could indicate whether the first system information is provided on a plurality of beams or not and/or whether the first system information associated with a plurality of SSBs is provided or not. The plurality of beams and/or the plurality of SSBs could be all beams and/or all SSBs of a cell. The plurality of beams and/or the plurality of SSBs could be a subset of beams and/or a subset of SSBs of a cell. Prior to initiate a random access procedure to request the first information, the UE could determine whether the first system information is provided by corresponding SSB(s) or not.

The UE receives an indication regarding a first system information is provided on which time occasion(s) and/or a first system information is provided with which periodicity and/or which offset and/or a first system information is scheduled by which search space. The periodicity of the first system information could be different from a periodicity of SSB. The periodicity of the first system information could be larger than a periodicity of SSB. The periodicity of the first system information could be a multiple times of a periodicity of SSB. For example, the indication could indicate the multiple.

The periodicity and/or the offset could be relative to time occasion(s) of SSB. SSB (e.g. SSB 0 or SSB1) would be transmitted periodically with a periodicity. SIB1 is provided in some SSB occasion(s) of an SSB (e.g. SSB 0 or SSB1) and is not provided in some other SSB occasion(s). For example, when the periodicity of the first system information is 4 times of SSB, the first system information associated with only one SSB occasion out of four consecutive periodic SSB occasions (e.g. each separated by SSB periodicity) is provided and the first system information associated with the other three SSB occasions out of four consecutive periodic SSB occasions is not provided

The periodicity and/or the offset could indicate the first system information is provided within which SSB period of a SSB (e.g. SSB 0 or SSB1). The periodicity and/or the offset could indicate the first system information is not provided within which SSB period of a SSB (e.g. SSB 0 or SSB1). The first system information could be SIB1. The first system information could be MIB. The first system information could be MIB of another serving cell (e.g. SCell).

The indication could be provided in RAR. The indication could be provided in RAR in response to preamble requesting SIB1. The indication could be provided in SSB. There could be multiple occasion(s)/periodicity (ies)/offset(s)/search space(s) configured, e.g. by RRC message. The indication indicates one out of the multiple values. The indication could be indicated together with indication of whether base station would provide the first system information. The indication could be indicated separately from indication of whether base station would provide the first system information. The indication could be indicated together and/or jointly with an indication of whether the first system information would be provided or not. The indication could be indicated together and/or jointly with an indication of whether the base station would wake up or not. The indication could be indicated together and/or jointly with an indication of whether request is accepted or not. The indication could indicates another time occasion and/or another search space provided in SSB/MIB is not applicable (e.g. currently). The indication could indicate time occasion and/or search space overriding another time occasion and/or another search space provided in SSB/MIB. The UE monitor/receive/acquire the first system information based on the indicated time occasion and/or search space and/or periodicity and/or offset.

Throughout the invention, “C-DRX” could be replaced by “DRX” or “DRX for a UE” or “UE DRX”.

Throughout the invention, the invention describes behavior or operation of a single serving cell unless otherwise noted.

Throughout the invention, the invention describes behavior or operation of multiple serving cells unless otherwise noted.

Throughout the invention, the invention describes behavior or operation of a single bandwidth part unless otherwise noted.

Throughout the invention, a base station configures multiple bandwidth parts to the UE unless otherwise noted.

Throughout the invention, a base station configures a single bandwidth part to the UE unless otherwise noted.

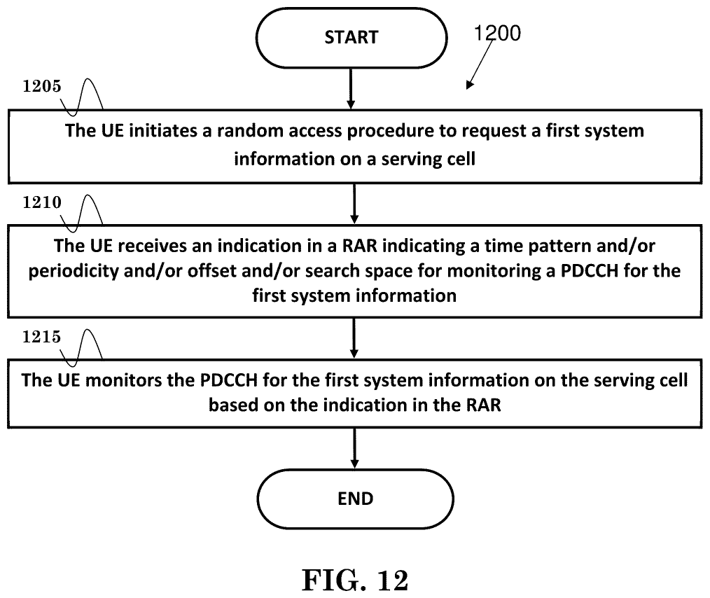

FIG. 12 is a flow chart 1200 for a User Equipment (UE). In step 1205, the UE initiates a random access procedure to request a first system information on a serving cell. In step 1210, the UE receives an indication in a RAR indicating a time pattern and/or periodicity and/or offset and/or search space for monitoring a PDCCH for the first system information. In step 1215, the UE monitors the PDCCH for the first system information on the serving cell based on the indication in the RAR.

In one embodiment, the first system information could be SIB-1. The indication could indicate time occasion(s) to monitor the PDCCH for the first system information. The time occasion(s) could be relative to time occasion(s) of a SSB. The periodicity could be a multiple of SSB periodicity.

Referring back to FIGS. 3 and 4, in one exemplary embodiment from the perspective of a UE. The UE 300 includes a program code 312 stored in the memory 310. The CPU 308 could execute program code 312 to enable the UE (i) to initiate a random access procedure to request a first system information on a serving cell, (ii) to receive an indication in a RAR indicating a time pattern and/or periodicity and/or offset and/or search space for monitoring a PDCCH for the first system information, and (iii) to monitor the PDCCH for the first system information on the serving cell based on the indication in the RAR. Furthermore, the CPU 308 can execute the program code 312 to perform all of the above-described actions and steps or others described herein.

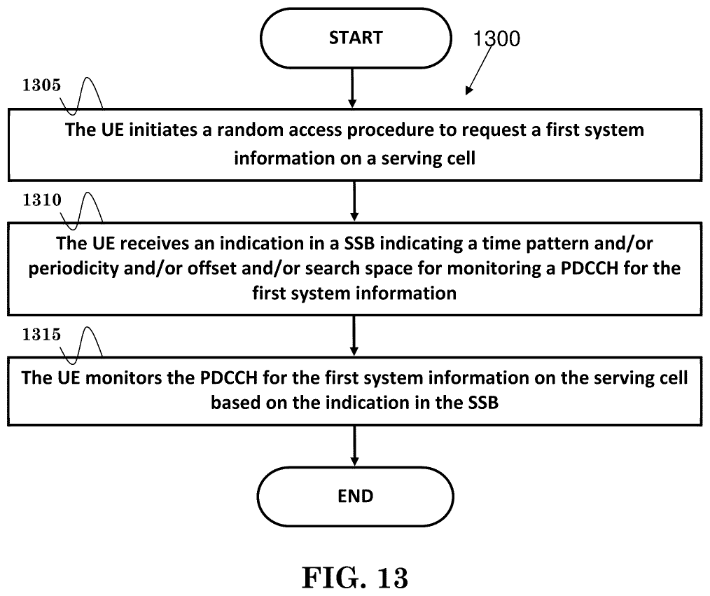

FIG. 13 is a flow chart 1300 for a User Equipment (UE). In step 1305, the UE initiates a random access procedure to request a first system information on a serving cell. In step 1310, the UE receives an indication in a SSB indicating a time pattern and/or periodicity and/or offset and/or search space for monitoring a PDCCH for the first system information. In step 1315, the UE monitors the PDCCH for the first system information on the serving cell based on the indication in the SSB.

In one embodiment, the first system information could be SIB-1. The indication could indicate time occasion(s) to monitor the PDCCH for the first system information. The time occasion(s) could be relative to time occasion(s) of the SSB. The periodicity could be a multiple of SSB periodicity.

Referring back to FIGS. 3 and 4, in one exemplary embodiment from the perspective of a UE. The UE 300 includes a program code 312 stored in the memory 310. The CPU 308 could execute program code 312 to enable the UE (i) to initiate a random access procedure to request a first system information on a serving cell, (ii) to receive an indication in a SSB indicating a time pattern and/or periodicity and/or offset and/or search space for monitoring a PDCCH for the first system information, and (iii) to monitor the PDCCH for the first system information on the serving cell based on the indication in the SSB. Furthermore, the CPU 308 can execute the program code 312 to perform all of the above-described actions and steps or others described herein.

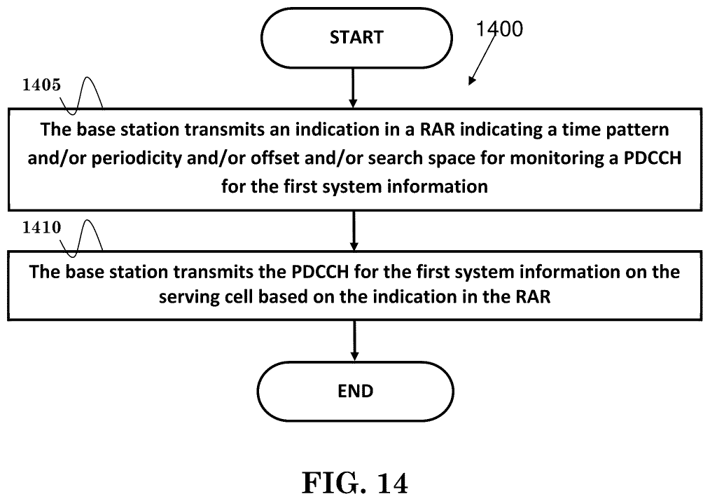

FIG. 14 is a flow chart 1400 for a base station. In step 1405, the base station transmits an indication in a RAR indicating a time pattern and/or periodicity and/or offset and/or search space for monitoring a PDCCH for the first system information. In step 1410, the base station transmits the PDCCH for the first system information on the serving cell based on the indication in the RAR.

In one embodiment, the first system information could be SIB-1. The indication could indicate time occasion(s) to transmit the PDCCH for the first system information. The time occasion(s) could be relative to time occasion(s) of a SSB. The periodicity could be a multiple of SSB periodicity.

Referring back to FIGS. 3 and 4, in one exemplary embodiment from the perspective of a base station. The base station 300 includes a program code 312 stored in the memory 310. The CPU 308 could execute program code 312 to enable the UE (i) to transmit an indication in a RAR indicating a time pattern and/or periodicity and/or offset and/or search space for monitoring a PDCCH for the first system information, and (ii) to transmit the PDCCH for the first system information on the serving cell based on the indication in the RAR. Furthermore, the CPU 308 can execute the program code 312 to perform all of the above-described actions and steps or others described herein.

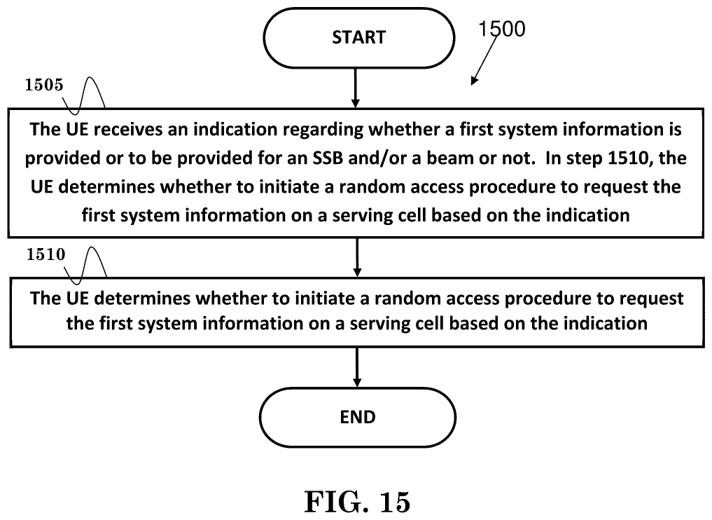

FIG. 15 is a flow chart 1500 for a User Equipment (UE). In step 1505, the UE receives an indication regarding whether a first system information is provided or to be provided for an SSB and/or a beam or not. In step 1510, the UE determines whether to initiate a random access procedure to request the first system information on a serving cell based on the indication.

In one embodiment, the UE does not initiate a random access procedure to request the first system information on a serving cell if/when first system information is provided or to be provided for an SSB that the UE is able to receives or acquire or detect. The UE initiates a random access procedure to request the first system information on a serving cell if/when first system information is not provided or not to be provided for an SSB that the UE is able to receives or acquire or detect. The UE initiates a random access procedure to request the first system information on a serving cell if/when first system information is not provided or not to be provided for all SSB that the UE is able to receives or acquire or detect. The UE initiates a random access procedure to request the first system information on a serving cell if/when the UE is able to receives or acquire or detect SSB(s) providing the first system information. The UE initiates a random access procedure to request the first system information on a serving cell if/when a current SSB does not provide the first system information.

Referring back to FIGS. 3 and 4, in one exemplary embodiment from the perspective of a UE. The UE 300 includes a program code 312 stored in the memory 310. The CPU 308 could execute program code 312 to enable the UE (i) to receive an indication regarding whether a first system information is provided or to be provided for an SSB and/or a beam or not, and (ii) to determine whether to initiate a random access procedure to request the first system information on a serving cell based on the indication. Furthermore, the CPU 308 can execute the program code 312 to perform all of the above-described actions and steps or others described herein.

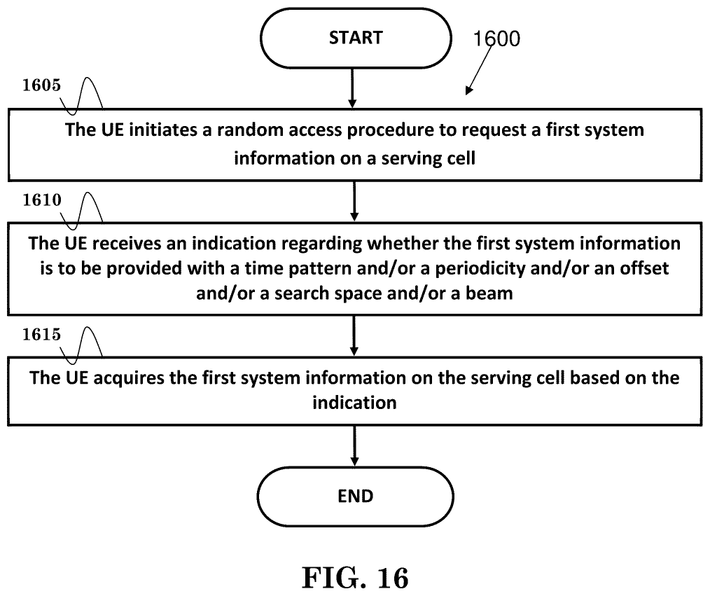

FIG. 16 is a flow chart 1600 for a User Equipment (UE). In step 1605, the UE initiates a random access procedure to request a first system information on a serving cell. In step 1610, the UE receives an indication regarding whether the first system information is to be provided with a time pattern and/or a periodicity and/or an offset and/or a search space and/or a beam. In step 1615, the UE acquires the first system information on the serving cell based on the indication.

Referring back to FIGS. 3 and 4, in one exemplary embodiment from the perspective of a UE. The UE 300 includes a program code 312 stored in the memory 310. The CPU 308 could execute program code 312 to enable the UE (i) to initiate a random access procedure to request a first system information on a serving cell, (ii) to receive an indication regarding whether the first system information is to be provided with a time pattern and/or a periodicity and/or an offset and/or a search space and/or a beam, and (iii) to acquire the first system information on the serving cell based on the indication. Furthermore, the CPU 308 can execute the program code 312 to perform all of the above-described actions and steps or others described herein.

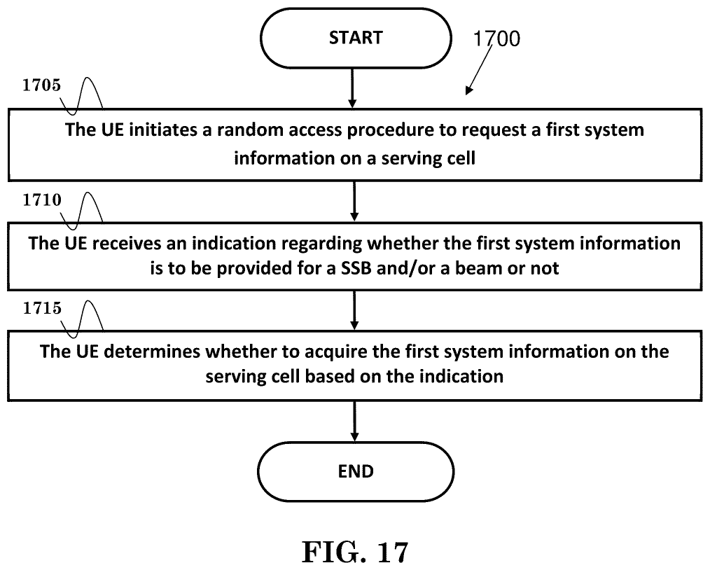

FIG. 17 is a flow chart 1700 for a User Equipment (UE). In step 1705, the UE initiates a random access procedure to request a first system information on a serving cell. In step 1710, the UE receives an indication regarding whether the first system information is to be provided for a SSB and/or a beam or not. In step 1715, the UE determines whether to acquire the first system information on the serving cell based on the indication.

Referring back to FIGS. 3 and 4, in one exemplary embodiment from the perspective of a UE. The UE 300 includes a program code 312 stored in the memory 310. The CPU 308 could execute program code 312 to enable the UE (i) to initiate a random access procedure to request a first system information on a serving cell, (ii) to receive an indication regarding whether the first system information is to be provided for a SSB and/or a beam or not, and (iii) to determine whether to acquire the first system information on the serving cell based on the indication. Furthermore, the CPU 308 can execute the program code 312 to perform all of the above-described actions and steps or others described herein.

In the context of the embodiments illustrated in FIGS. 15, 16, and 17 and discussed above, in one embodiment, the first system information could be SIB1. The indication could be indicated by or carried on a random access response of the random access procedure. The indication could be indicated by or carried on a SSB. The indication could indicate whether the first system information is to be provided for one SSB. The indication could indicate whether the first system information is to be provided for each SSB of a multiple SSBs of the serving cell. The multiple SSBs could be all SSBs of a serving cell. The SSB could be a SSB selected during the random access procedure.

In one embodiment, the UE could acquire the first system information on the serving cell if/when the UE is able to receive or acquire the SSB. The UE may not acquire the first system information on the serving cell if/when the indication indicates the first system information is not to be provided. The UE could determine whether to perform cell selection/reselection based on the indication. The UE could perform connection to the serving cell if/when the indication indicates the first system information is to be provided. The UE could select/re-select another serving cell if/when the indication indicates the first system information is not to be provided.

Various aspects of the disclosure have been described above. It should be apparent that the teachings herein could be embodied in a wide variety of forms and that any specific structure, function, or both being disclosed herein is merely representative. Based on the teachings herein one skilled in the art should appreciate that an aspect disclosed herein could be implemented independently of any other aspects and that two or more of these aspects could be combined in various ways. For example, an apparatus could be implemented or a method could be practiced using any number of the aspects set forth herein. In addition, such an apparatus could be implemented or such a method could be practiced using other structure, functionality, or structure and functionality in addition to or other than one or more of the aspects set forth herein. As an example of some of the above concepts, in some aspects concurrent channels could be established based on pulse repetition frequencies. In some aspects concurrent channels could be established based on pulse position or offsets. In some aspects concurrent channels could be established based on time hopping sequences. In some aspects concurrent channels could be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for a User Equipment (UE), comprising:
the UE initiates a random access procedure to request a first system information on a serving cell;
the UE receives an indication in a Random Access Response (RAR) indicating a time pattern and/or periodicity and/or offset and/or search space for monitoring a Physical Downlink Control Channel (PDCCH) for the first system information; and
the UE monitors the PDCCH for the first system information on the serving cell based on the indication in the RAR.

2. The method of claim 1, wherein the first system information is SIB-1.

3. The method of claim 1, wherein the indication indicates time occasion(s) to monitor the PDCCH for the first system information.

4. The method of claim 3, wherein the time occasion(s) is relative to time occasion(s) of a Synchronization Signal Block (SSB).

5. The method of claim 4, wherein the periodicity is a multiple of SSB periodicity.

6. A method for a User Equipment (UE), comprising:
the UE initiates a random access procedure to request a first system information on a serving cell;
the UE receives an indication in a Synchronization Signal Block (SSB) indicating a time pattern and/or periodicity and/or offset and/or search space for monitoring a Physical Downlink Control Channel (PDCCH) for the first system information; and
the UE monitors the PDCCH for the first system information on the serving cell based on the indication in the SSB.

7. The method of claim 6, wherein the first system information is SIB-1.

8. The method of claim 6, wherein the indication indicates time occasion(s) to monitor the PDCCH for the first system information.

9. The method of claim 8, wherein the time occasion(s) is relative to time occasion(s) of the SSB.

10. The method of claim 6, wherein the periodicity is a multiple of SSB periodicity.

11. A method for a base station, comprising:
the base station transmits an indication in a Random Access Response (RAR) indicating a time pattern and/or periodicity and/or offset and/or search space for monitoring a Physical Downlink Control Channel (PDCCH) for the first system information; and
the base station transmits the PDCCH for the first system information on the serving cell based on the indication in the RAR.

12. The method of claim 11, wherein the first system information is SIB-1.

13. The method of claim 11, wherein the indication indicates time occasion(s) to transmit the PDCCH for the first system information.

14. The method of claim 13, wherein the time occasion(s) is relative to time occasion(s) of a SSB.

15. The method of claim 14, wherein the periodicity is a multiple of SSB periodicity.
